(19) United States
(12) Patent Application Publication
(10) Pub. No.: US 2026/0205760 A1
(43) Pub. Date: Jul. 16, 2026

(54) DISTRIBUTED AUDIO DEVICE DUCKING

(71) Applicant: DOLBY LABORATORIES LICENSING CORPORATION, San Francisco, CA (US)

(72) Inventors: Benjamin Southwell, Gledswood Hills (AU); David Gunawan, Sydney (AU); Alan J. Seefeldt, Alameda, CA (US)

(73) Assignee: DOLBY LABORATORIES LICENSING CORPORATION, San Francisco, CA (US)

(21) Appl. No.: 18/707,832

(22) PCT Filed: Nov. 4, 2022
(86) PCT No.: PCT/US2022/048956

§ 371 Date: May 6, 2024

Related U.S. Application Data
(60) Provisional application No. 63/278,003, filed on Nov. 10, 2021.
(60) Provisional application No. 63/362,842, filed on Apr. 12, 2022.

(30) Foreign Application Priority Data
Apr. 12, 2022 (EP) 22167857.6

(51) Int. Cl. H04S 7/00; G06F 3/16

(52) U.S. Cl. CPC H04S 7/305; G06F 3/165; H04S 7/302

(57) ABSTRACT

An audio processing method may involve receiving output signals from each microphone of a plurality of microphones in an audio environment, the output signals corresponding to a current utterance of a person. The method may involve determining, responsive to the output signals and based at least in part on audio device location information and echo management system information, one or more audio processing changes to apply to audio data being rendered to loudspeaker feed signals for two or more audio devices in the audio environment. The audio processing changes may involve a reduction in a loudspeaker reproduction level for one or more loudspeakers in the audio environment. The method may involve causing one or more types of audio processing changes to be applied. The audio processing changes may have the effect of increasing a speech to echo ratio at one or more microphones.

### CROSS-REFERENCE TO RELATED APPLICATION

This application claims priority to U.S. provisional application 63/278,003, filed Nov. 10, 2021, U.S. provisional application 63/362,842, filed Apr. 12, 2022 and to EP Application Serial No. 22167857.6, filed Apr. 12, 2022, all of which is incorporated herein by reference in its entirety.

### TECHNICAL FIELD

The present disclosure pertains to systems and methods for orchestrating and implementing audio devices, such as smart audio devices, and controlling speech-to-echo ratio (SER) in such audio devices.

### BACKGROUND

Audio devices, including but not limited to smart audio devices, have been widely deployed and are becoming common features of many homes. Although existing systems and methods for controlling audio devices provide benefits, improved systems and methods would be desirable.

### NOTATION AND NOMENCLATURE

Throughout this disclosure, including in the claims, the terms “speaker,” “loudspeaker” and “audio reproduction transducer” are used synonymously to denote any sound-emitting transducer (or set of transducers). A typical set of headphones includes two speakers. A speaker may be implemented to include multiple transducers (e.g., a woofer and a tweeter), which may be driven by a single, common speaker feed or multiple speaker feeds. In some examples, the speaker feed(s) may undergo different processing in different circuitry branches coupled to the different transducers.

Throughout this disclosure, including in the claims, the expression performing an operation “on” a signal or data (e.g., filtering, scaling, transforming, or applying gain to, the signal or data) is used in a broad sense to denote performing the operation directly on the signal or data, or on a processed version of the signal or data (e.g., on a version of the signal that has undergone preliminary filtering or pre-processing prior to performance of the operation thereon).

Throughout this disclosure including in the claims, the expression “system” is used in a broad sense to denote a device, system, or subsystem. For example, a subsystem that implements a decoder may be referred to as a decoder system, and a system including such a subsystem (e.g., a system that generates X output signals in response to multiple inputs, in which the subsystem generates M of the inputs and the other X−M inputs are received from an external source) may also be referred to as a decoder system.

Throughout this disclosure including in the claims, the term “processor” is used in a broad sense to denote a system or device programmable or otherwise configurable (e.g., with software or firmware) to perform operations on data (e.g., audio, or video or other image data). Examples of processors include a field-programmable gate array (or other configurable integrated circuit or chip set), a digital signal processor programmed and/or otherwise configured to perform pipelined processing on audio or other sound data, a programmable general purpose processor or computer, and a programmable microprocessor chip or chip set.

Throughout this disclosure including in the claims, the term “couples” or “coupled” is used to mean either a direct or indirect connection. Thus, if a first device couples to a second device, that connection may be through a direct connection, or through an indirect connection via other devices and connections.

As used herein, a “smart device” is an electronic device, generally configured for communication with one or more other devices (or networks) via various wireless protocols such as Bluetooth, Zigbee, near-field communication, Wi-Fi, light fidelity (Li-Fi), 3G, 4G, 5G, etc., that can operate to some extent interactively and/or autonomously. Several notable types of smart devices are smartphones, smart cars, smart thermostats, smart doorbells, smart locks, smart refrigerators, phablets and tablets, smartwatches, smart bands, smart key chains and smart audio devices. The term “smart device” may also refer to a device that exhibits some properties of ubiquitous computing, such as artificial intelligence.

Herein, we use the expression “smart audio device” to denote a smart device which is either a single-purpose audio device or a multi-purpose audio device (e.g., an audio device that implements at least some aspects of virtual assistant functionality). A single-purpose audio device is a device (e.g., a television (TV)) including or coupled to at least one microphone (and optionally also including or coupled to at least one speaker and/or at least one camera), and which is designed largely or primarily to achieve a single purpose. For example, although a TV typically can play (and is thought of as being capable of playing) audio from program material, in most instances a modern TV runs some operating system on which applications run locally, including the application of watching television. In this sense, a single-purpose audio device having speaker(s) and microphone(s) is often configured to run a local application and/or service to use the speaker(s) and microphone(s) directly. Some single-purpose audio devices may be configured to group together to achieve playing of audio over a zone or user configured area.

One common type of multi-purpose audio device is an audio device that implements at least some aspects of virtual assistant functionality, although other aspects of virtual assistant functionality may be implemented by one or more other devices, such as one or more servers with which the multi-purpose audio device is configured for communication. Such a multi-purpose audio device may be referred to herein as a “virtual assistant.” A virtual assistant is a device (e.g., a smart speaker or voice assistant integrated device) including or coupled to at least one microphone (and optionally also including or coupled to at least one speaker and/or at least one camera). In some examples, a virtual assistant may provide an ability to utilize multiple devices (distinct from the virtual assistant) for applications that are in a sense cloud-enabled or otherwise not completely implemented in or on the virtual assistant itself. In other words, at least some aspects of virtual assistant functionality, e.g., speech recognition functionality, may be implemented (at least in part) by one or more servers or other devices with which a virtual assistant may communication via a network, such as the Internet. Virtual assistants may sometimes work together, e.g., in a discrete and conditionally defined way. For example, two or more virtual assistants may work together in the sense that one of them, e.g., the one which is most confident that it has heard a wakeword, responds to the wakeword. The connected virtual assistants may, in some implementations, form a sort of constellation, which may be managed by one main application which may be (or implement) a virtual assistant.

Herein, “wakeword” is used in a broad sense to denote any sound (e.g., a word uttered by a human, or some other sound), where a smart audio device is configured to awake in response to detection of (“hearing”) the sound (using at least one microphone included in or coupled to the smart audio device, or at least one other microphone). In this context, to “awake” denotes that the device enters a state in which it awaits (in other words, is listening for) a sound command. In some instances, what may be referred to herein as a “wakeword” may include more than one word, e.g., a phrase.

Herein, the expression “wakeword detector” denotes a device configured (or software that includes instructions for configuring a device) to search continuously for alignment between real-time sound (e.g., speech) features and a trained model. Typically, a wakeword event is triggered whenever it is determined by a wakeword detector that the probability that a wakeword has been detected exceeds a predefined threshold. For example, the threshold may be a predetermined threshold which is tuned to give a reasonable compromise between rates of false acceptance and false rejection. Following a wakeword event, a device might enter a state (which may be referred to as an “awakened” state or a state of “attentiveness”) in which it listens for a command and passes on a received command to a larger, more computationally-intensive recognizer.

As used herein, the terms “program stream” and “content stream” refer to a collection of one or more audio signals, and in some instances video signals, at least portions of which are meant to be heard together. Examples include a selection of music, a movie soundtrack, a movie, a television program, the audio portion of a television program, a podcast, a live voice call, a synthesized voice response from a smart assistant, etc. In some instances, the content stream may include multiple versions of at least a portion of the audio signals, e.g., the same dialogue in more than one language. In such instances, only one version of the audio data or portion thereof (e.g., a version corresponding to a single language) is intended to be reproduced at one time.

### SUMMARY

At least some aspects of the present disclosure may be implemented via one or more audio processing methods. In some instances, the method(s) may be implemented, at least in part, by a control system and/or via instructions (e.g., software) stored on one or more non-transitory media. Some such methods may involve receiving, by a control system, output signals from one or more microphones in an audio environment. The output signals may, in some instances, include signals corresponding to a current utterance of a person. In some such examples, the current utterance may be, or may include, a wakeword utterance.

Some such methods may involve determining, by the control system, responsive to the output signals and based at least in part on audio device location information and echo management system information, one or more audio processing changes to apply to audio data being rendered to loudspeaker feed signals for two or more audio devices in the audio environment. In some examples, the audio processing changes may involve a reduction in a loudspeaker reproduction level for one or more loudspeakers in the audio environment. Some such methods may involve causing, by the control system, the one or more types of audio processing changes to be applied.

In some examples, at least one of the audio processing changes may correspond with an increased signal to echo ratio. According to some such examples, the echo management system information may include a model of echo management system performance. For example, the model of echo management system performance may include an acoustic echo canceller (AEC) performance matrix. In some examples, the model of echo management system performance may include a measure of expected echo return loss enhancement provided by an echo management system.

According to some examples, determining the one or more types of audio processing changes may be based, at least in part, on optimization of a cost function. Alternatively, or additionally, in some examples one or more types of audio processing changes may be based, at least in part, on an acoustic model of inter-device echo and intra-device echo. Alternatively, or additionally, in some examples one or more types of audio processing changes may be based, at least in part, on the mutual audibility of audio devices in the audio environment, e.g., on a mutual audibility matrix.

In some examples, one or more types of audio processing changes may be based, at least in part, on an estimated location of the person. In some such examples, the estimated location of the person may be based, at least in part, on output signals from a plurality of microphones in the audio environment. According to some such examples, the audio processing changes may involve changing a rendering process to warp a rendering of audio signals away from the estimated location of the person.

Alternatively, or additionally, in some examples one or more types of audio processing changes may be based, at least in part, on a listening objective. In some such examples, the listening objective may include a spatial component, a frequency component, or both a spatial component and a frequency component.

Alternatively, or additionally, in some examples one or more types of audio processing changes may be based, at least in part, on one or more constraints. In some such examples, the one or more constraints may be based, at least in part, on a perceptual model. Alternatively, or additionally, the one or more constraints may be based, at least in part, on audio content energy preservation, audio spatiality preservation, an audio energy vector, a regularization constraint, or combinations thereof. Alternatively, or additionally, some examples may involve updating an acoustic model of the audio environment, a model of echo management system performance, or both, after causing the one or more types of audio processing changes to be applied.

In some examples, the one or more types of audio processing changes may involve spectral modification. In some such examples, the spectral modification may involve reducing a level of audio data in a frequency band between 500 Hz and 3 KHz.

Aspects of some disclosed implementations include a control system configured (e.g., programmed) to perform one or more disclosed methods or steps thereof, and a tangible, non-transitory, computer readable medium which implements non-transitory storage of data (for example, a disc or other tangible storage medium) which stores code for performing (e.g., code executable to perform) one or more disclosed methods or steps thereof. For example, some disclosed embodiments can be or include a programmable general purpose processor, digital signal processor, or microprocessor, programmed with software or firmware and/or otherwise configured to perform any of a variety of operations on data, including one or more disclosed methods or steps thereof. Such a general purpose processor may be or include a computer system including an input device, a memory, and a processing subsystem that is programmed (and/or otherwise configured) to perform one or more disclosed methods (or steps thereof) in response to data asserted thereto.

Some or all of the operations, functions and/or methods described herein may be performed by one or more devices according to instructions (e.g., software) stored on one or more non-transitory media. Such non-transitory media may include memory devices such as those described herein, including but not limited to random access memory (RAM) devices, read-only memory (ROM) devices, etc. Accordingly, some innovative aspects of the subject matter described in this disclosure can be implemented in a non-transitory medium having software stored thereon.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1A is a block diagram that shows examples of components of an apparatus capable of implementing various aspects of this disclosure.

FIG. 1B shows an example of an audio environment.

FIG. 2 shows echo paths between three of the audio devices of FIG. 1B.

FIG. 3 is a system block diagram that represents components of audio devices according to one example.

FIG. 4 shows elements of a ducking module according to one example.

FIG. 5 is a block diagram that shows an example of an audio device that includes a ducking module.

FIG. 6 is a block diagram that shows an alternative example of an audio device that includes a ducking module.

FIG. 7 is a flow diagram that outlines one example of a method for determining a ducking solution.

FIG. 8 is a flow diagram that outlines another example of a method for determining a ducking solution.

FIG. 9 is a flow diagram that outlines an example of a disclosed method.

FIG. 10 is a flow diagram that outlines one example of a method that may be performed by an apparatus such as that shown in FIG. 1A.

FIG. 11 is a block diagram of elements of one example of an embodiment that is configured to implement a zone classifier.

FIG. 12 is a flow diagram that outlines one example of a method that may be performed by an apparatus such as apparatus 150 of FIG. 1A.

FIG. 13 is a flow diagram that outlines another example of a method that may be performed by an apparatus such as apparatus 150 of FIG. 1A.

FIG. 14 is a flow diagram that outlines another example of a method that may be performed by an apparatus such as apparatus 150 of FIG. 1A.

FIGS. 15 and 16 are diagrams which illustrate an example set of speaker activations and object rendering positions.

FIG. 17 is a flow diagram that outlines one example of a method that may be performed by an apparatus or system such as that shown in FIG. 1A.

FIG. 18 is a graph of speaker activations in an example embodiment.

FIG. 19 is a graph of object rendering positions in an example embodiment.

FIG. 20 is a graph of speaker activations in an example embodiment.

FIG. 21 is a graph of object rendering positions in an example embodiment.

FIG. 22 is a graph of speaker activations in an example embodiment.

FIG. 23 is a graph of object rendering positions in an example embodiment.

### DETAILED DESCRIPTION

Some embodiments are configured to implement a system that includes coordinated audio devices, which are also referred to herein as orchestrated audio devices. In some implementations, the orchestrated audio devices may include smart audio devices. According to some such implementations, two or more of the smart audio devices may be, or may be configured to implement, a wakeword detector. Accordingly, multiple microphones (e.g., asynchronous microphones) may be present in an audio environment in such examples.

At present, designers generally consider audio devices as a single point of interface for audio that may be a blend of entertainment, communications and information services. Using audio for notifications and voice control has the advantage of avoiding visual or physical intrusion. In all forms of interactive audio, the problem of improving full duplex (input and output) audio ability remains a challenge. When there is audio output in the room that is not relevant for transmission or information-based capture in the room, it is desirable to remove this audio from the captured signal (e.g., by echo cancellation and/or echo suppression).

Some disclosed embodiments provide an approach for management of the listener or “user” experience to improve a key criterion for successful full duplex at one or more audio devices. This criterion is known as the Signal to Echo ratio (SER), also referred to herein as the Speech to Echo Ratio, which may be defined as the ratio between the voice signal, or other desired signal, to be captured in an audio environment (e.g., a room) via one or more microphones, and the “echo” presented at the audio device that includes signals from the one or more microphones corresponding to output program content, interactive content, etc., that is being played back by one or more loudspeakers of the audio environment. Those of skill in the art will realize that in this context an “echo” is not necessarily reflected before being captured by a microphone.

Such embodiments may be useful in situations where there is more than one audio device within acoustic range of the user, such that each audio device would be able to present audio program material that is suitably loud at the user's location for a desired entertainment, communications or information service. The value of such embodiments may be particularly high when there are three or more audio devices similarly proximate to the user. If audio devices are closer to the user, the audio devices can be more advantageous in terms of the ability to accurately locate sound or deliver specific audio signalling and imaging to the user. However, if these audio devices include one or more microphones, one or more of these audio devices also may have a microphone system that is preferable for picking up the user's voice.

An audio device may often need to respond to a user's voice command while the audio device is playing content, in which case the audio device's microphone system will detect content played back by the audio device: put another way, the audio device will hear its own “echo.” Due to the specialized nature of wakeword detectors, such devices may be able to perform better than more general speech recognition engines in the presence of this echo. A common mechanism implemented in these audio devices, which is commonly referred to as “ducking,” involves a reduction in the playback level of the audio device after detecting the wakeword, so that the audio device can better recognize a post-wakeword command uttered by the user. Such ducking generally results in an improved SER, which is a common metric for predicting speech recognition performance.

In a distributed and orchestrated audio device context, in which multiple audio devices are located in a single acoustic space (also referred to herein as an “audio environment”), ducking only the playback of a single audio device may not be an optimal solution. This may be true in part because the “echo” (detected audio playback) from other, non-ducked, audio devices in the audio environment may cause the maximum achievable SER, by way of ducking only the playback of a single audio device, to be limited.

Accordingly, some disclosed embodiments may cause audio processing changes for two or more audio devices of an audio environment, in order to increase the SER at one or more microphones of the audio environment. In some examples, the audio processing change(s) may be determined according to the result of an optimization process. According to some examples, the optimization process may involve trading off objective sound capture performance objectives against constraints that preserve one or more aspects of the user's listening experience. In some examples, the constraints may be perceptual constraints, objective constraints, or combinations thereof. Some disclosed examples involve implementing models that describe the echo management signal chain, which also may be referred to herein as the “capture stack,” the acoustic space and the perceptual impact of the audio processing change(s), and trading them off explicitly (e.g., seeking a solution taking all such factors into account).

According to some examples, the process may involve a closed loop system in which the acoustic and capture stack models are updated, for example after each audio processing change (such as each change of one or more rendering parameters). Some such examples may involve iteratively improving an audio system's performance over time.

Some disclosed implementations may be based, at least in part, on one or more of the following factors, or a combination thereof:
Models of the acoustic environment (in other words, the acoustics of the audio environment) and the echo management signal chain which can predict the achieved SER for a given configuration and output solution;
Constraints which bound the output solution according to both objective and subjective metrics, which may include:
   Content energy preservation;
   Spatiality preservation;
   Energy vectors; and/or
   Regularization, such as:
      Level 1 regularization (L1), level 2 regularization (L2), or any level of regularization (LN) distortion of a two-dimensional or three-dimensional array of loudspeaker activations, which may be referred to herein as a “waffle”; and/or
      L1, L2 or LN regularization of ducking gains;
A listening objective, which may determine both the spatial and level component in the target solution.

According to some examples, the ducking solution may be based, at least in part, on one or more of the following factors, or a combination thereof:
Simple gains which may, in some examples, be applied to audio content that has already been rendered;
   These gains may be full-band or frequency-dependent, depending on the particular implementation;
Inputs to the renderer which the renderer may use, in some examples, in combination with a waffle; and/or
Inputs to a device, module, etc., which generates the waffle, which may be referred to herein as a waffle maker and which, in some instances, may be a component of the renderer. The waffle maker may, in some examples, use such inputs to generate a ducked waffle.

In some implementations, such inputs to a waffle maker and/or to a renderer may be used to alter the audio playback such that audio objects may seem to be “pushed away” from a location at which a wakeword has been detected. Some such implementations may involve determining relative activations of a set of loudspeakers in an audio environment by optimizing a cost that is a function of the following: (a) a model of perceived spatial position of an audio signal played when played back over a set of loudspeakers in the audio environment; (b) a measure of proximity of the intended perceived spatial position of the audio signal to a position of each loudspeaker of the set of loudspeakers; and (c) one or more additional dynamically configurable functions. Some such implementations will be described in detail below.

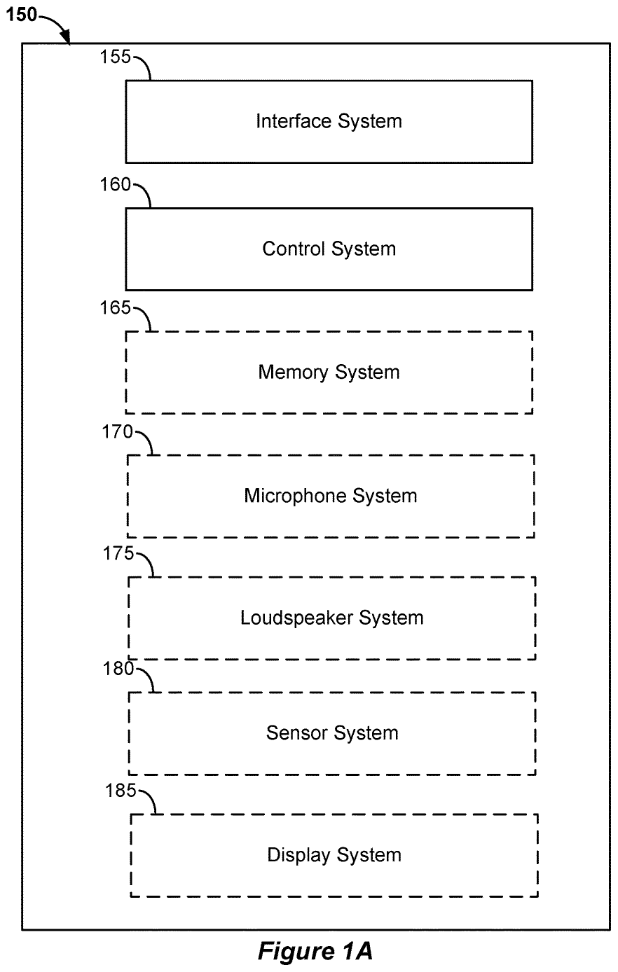

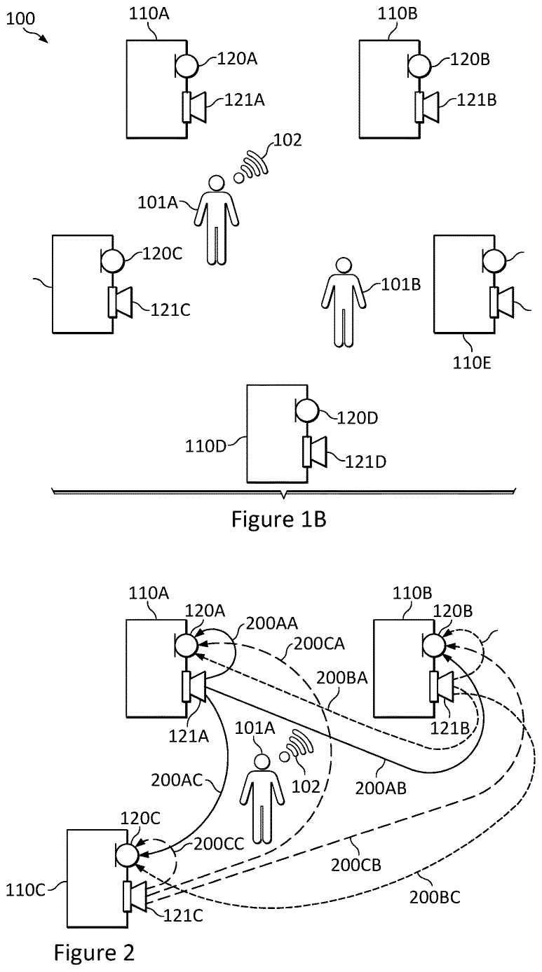

FIG. 1A is a block diagram that shows examples of components of an apparatus capable of implementing various aspects of this disclosure. As with other figures provided herein, the types and numbers of elements shown in FIG. 1A are merely provided by way of example. Other implementations may include more, fewer and/or different types and numbers of elements. According to some examples, the apparatus 150 may be configured for performing at least some of the methods disclosed herein. In some implementations, the apparatus 150 may be, or may include, one or more components of an audio system. For example, the apparatus 150 may be an audio device, such as a smart audio device, in some implementations. In other examples, the examples, the apparatus 150 may be a mobile device (such as a cellular telephone), a laptop computer, a tablet device, a television or another type of device.

According to some alternative implementations the apparatus 150 may be, or may include, a server. In some such examples, the apparatus 150 may be, or may include, an encoder. Accordingly, in some instances the apparatus 150 may be a device that is configured for use within an audio environment, such as a home audio environment, whereas in other instances the apparatus 150 may be a device that is configured for use in “the cloud,” e.g., a server.

In this example, the apparatus 150 includes an interface system 155 and a control system 160. The interface system 155 may, in some implementations, be configured for communication with one or more other devices of an audio environment. The audio environment may, in some examples, be a home audio environment. In other examples, the audio environment may be another type of environment, such as an office environment, an automobile environment, a train environment, a street or sidewalk environment, a park environment, etc. The interface system 155 may, in some implementations, be configured for exchanging control information and associated data with audio devices of the audio environment. The control information and associated data may, in some examples, pertain to one or more software applications that the apparatus 150 is executing.

The interface system 155 may, in some implementations, be configured for receiving, or for providing, a content stream. The content stream may include audio data. The audio data may include, but may not be limited to, audio signals. In some instances, the audio data may include spatial data, such as channel data and/or spatial metadata. Metadata may, for example, have been provided by what may be referred to herein as an “encoder.” In some examples, the content stream may include video data and audio data corresponding to the video data.

The interface system 155 may include one or more network interfaces and/or one or more external device interfaces (such as one or more universal serial bus (USB) interfaces). According to some implementations, the interface system 155 may include one or more wireless interfaces. The interface system 155 may include one or more devices for implementing a user interface, such as one or more microphones, one or more speakers, a display system, a touch sensor system and/or a gesture sensor system. In some examples, the interface system 155 may include one or more interfaces between the control system 160 and a memory system, such as the optional memory system 165 shown in FIG. 1A. However, the control system 160 may include a memory system in some instances. The interface system 155 may, in some implementations, be configured for receiving input from one or more microphones in an environment.

The control system 160 may, for example, include a general purpose single- or multi-chip processor, a digital signal processor (DSP), an application specific integrated circuit (ASIC), a field programmable gate array (FPGA) or other programmable logic device, discrete gate or transistor logic, and/or discrete hardware components.

In some implementations, the control system 160 may reside in more than one device. For example, in some implementations a portion of the control system 160 may reside in a device within one of the environments depicted herein and another portion of the control system 160 may reside in a device that is outside the environment, such as a server, a mobile device (e.g., a smartphone or a tablet computer), etc. In other examples, a portion of the control system 160 may reside in a device within one of the environments depicted herein and another portion of the control system 160 may reside in one or more other devices of the environment. For example, control system functionality may be distributed across multiple smart audio devices of an environment, or may be shared by an orchestrating device (such as what may be referred to herein as a smart home hub) and one or more other devices of the environment. In other examples, a portion of the control system 160 may reside in a device that is implementing a cloud-based service, such as a server, and another portion of the control system 160 may reside in another device that is implementing the cloud-based service, such as another server, a memory device, etc. The interface system 155 also may, in some examples, reside in more than one device.

In some implementations, the control system 160 may be configured for performing, at least in part, the methods disclosed herein. According to some examples, the control system 160 may be configured to determine and cause audio processing changes for two or more audio devices of an audio environment, in order to increase the SER at one or more microphones of the audio environment. In some examples, the audio processing change(s) may be based at least in part on audio device location information and echo management system information. According to some examples, the audio processing change(s) may be responsive to microphone output signals corresponding to a current utterance of a person, such as the utterance of a wakeword. In some examples, the audio processing change(s) may be determined according to the result of an optimization process. According to some examples, the optimization process may involve trading off objective sound capture performance objectives against constraints that preserve one or more aspects of the user's listening experience. In some examples, the constraints may be perceptual constraints, objective constraints, or combinations thereof.

Some or all of the methods described herein may be performed by one or more devices according to instructions (e.g., software) stored on one or more non-transitory media. Such non-transitory media may include memory devices such as those described herein, including but not limited to random access memory (RAM) devices, read-only memory (ROM) devices, etc. The one or more non-transitory media may, for example, reside in the optional memory system 165 shown in FIG. 1A and/or in the control system 160. Accordingly, various innovative aspects of the subject matter described in this disclosure can be implemented in one or more non-transitory media having software stored thereon. The software may, for example, include instructions for controlling at least one device to perform some or all of the methods disclosed herein. The software may, for example, be executable by one or more components of a control system such as the control system 160 of FIG. 1A.

In some examples, the apparatus 150 may include the optional microphone system 170 shown in FIG. 1A. The optional microphone system 170 may include one or more microphones. According to some examples, the optional microphone system 170 may include an array of microphones. In some examples, the array of microphones may be configured to determine direction of arrival (DOA) and/or time of arrival (TOA) information, e.g., according to instructions from the control system 160. The array of microphones may, in some instances, be configured for receive-side beamforming, e.g., according to instructions from the control system 160. In some implementations, one or more of the microphones may be part of, or associated with, another device, such as a speaker of the speaker system, a smart audio device, etc. In some examples, the apparatus 150 may not include a microphone system 170. However, in some such implementations the apparatus 150 may nonetheless be configured to receive microphone data for one or more microphones in an audio environment via the interface system 160. In some such implementations, a cloud-based implementation of the apparatus 150 may be configured to receive microphone data, or data corresponding to the microphone data, from one or more microphones in an audio environment via the interface system 160.

According to some implementations, the apparatus 150 may include the optional loudspeaker system 175 shown in FIG. 1A. The optional loudspeaker system 175 may include one or more loudspeakers, which also may be referred to herein as “speakers” or, more generally, as “audio reproduction transducers.” In some examples (e.g., cloud-based implementations), the apparatus 150 may not include a loudspeaker system 175.

In some implementations, the apparatus 150 may include the optional sensor system 180 shown in FIG. 1A. The optional sensor system 180 may include one or more touch sensors, gesture sensors, motion detectors, etc. According to some implementations, the optional sensor system 180 may include one or more cameras. In some implementations, the cameras may be free-standing cameras. In some examples, one or more cameras of the optional sensor system 180 may reside in a smart audio device, which may in some examples be configured to implement, at least in part, a virtual assistant. In some such examples, one or more cameras of the optional sensor system 180 may reside in a television, a mobile phone or a smart speaker. In some examples, the apparatus 150 may not include a sensor system 180. However, in some such implementations the apparatus 150 may nonetheless be configured to receive sensor data for one or more sensors in an audio environment via the interface system 160.

In some implementations, the apparatus 150 may include the optional display system 185 shown in FIG. 1A. The optional display system 185 may include one or more displays, such as one or more light-emitting diode (LED) displays. In some instances, the optional display system 185 may include one or more organic light-emitting diode (OLED) displays. In some examples, the optional display system 185 may include one or more displays of a smart audio device. In other examples, the optional display system 185 may include a television display, a laptop display, a mobile device display, or another type of display. In some examples wherein the apparatus 150 includes the display system 185, the sensor system 180 may include a touch sensor system and/or a gesture sensor system proximate one or more displays of the display system 185. According to some such implementations, the control system 160 may be configured for controlling the display system 185 to present one or more graphical user interfaces (GUIs).

According to some such examples the apparatus 150 may be, or may include, a smart audio device. In some such implementations the apparatus 150 may be, or may include, a wakeword detector. For example, the apparatus 150 may be, or may include, a virtual assistant.

FIG. 1B shows an example of an audio environment. As with other figures provided herein, the types, numbers and arrangement of elements shown in FIG. 1B are merely provided by way of example. Other implementations may include more, fewer and/or different types and numbers of elements, differently arranged elements, etc.

According to this example, the audio environment 100 includes audio devices 110A, 110B, 110C, 110D and 110E. The audio devices 110A-110E may, in some examples, be instances of the apparatus 150 of FIG. 1A. In this example, each the audio devices 110A-110E includes at least a respective one of the microphones 120A, 120B, 120C, 120D and 120E, as well as at least a respective one of the loudspeakers 121A, 121B, 121C, 121D and 121E. In this example, individual instances of the microphones 120A-120E and the loudspeakers 121A-121E are shown. However, one or more of the audio devices 110A-110E may include a microphone system that includes multiple microphones and/or a loudspeaker system that includes multiple loudspeakers. According to some examples, each the audio devices 110A-110E may be a smart audio device, such as a smart speaker.

In some examples, some or all of the audio devices 110A-110E may be orchestrated audio devices, operating (at least in part) according to instructions from an orchestrating device. According to some such examples, the orchestrating device may be one of the audio devices 110A-110E. In other examples, the orchestrating device may be another device, such as a smart home hub.

In this instance, persons 101A and 101B are in the audio environment. In this example, an acoustic event is caused by the talking person 101A, who is talking in the vicinity of the audio device 110A. Element 102 is intended to represent speech of the person 101A. In this example, the speech 102 corresponds to the utterance of a wakeword by the person 101A.

FIG. 2 shows echo paths between three of the audio devices of FIG. 1B. The elements of FIG. 2 that have not been described with reference to FIG. 1B are as follows:
200AA: echo path from device 110A to device 110A (from loudspeaker 121A to microphone 120A);
200AB: echo path from device 110A to device 110B (from loudspeaker 121A to microphone 120B);
200AC: echo path from device 110A to device 110C (from loudspeaker 121A to microphone 120C);
200BA: echo path from device 110B to device 110A (from loudspeaker 121B to microphone 120A);
200BB: echo path from device 110B to device 110B (from loudspeaker 121B to microphone 120B);
200BC: echo path from device 110B to device 110C (from loudspeaker 121B to microphone 120C);
200CA: echo path from device 110C to device 110A (from loudspeaker 121C to microphone 120A);
200CB: echo path from device 110C to device 110C (from loudspeaker 121C to microphone 120B); and
200CC: echo path from device 110C to device 110C (from loudspeaker 121C to microphone 120C).

These echo paths indicate of the impact each audio device's played-back audio or “echo” has on the other audio devices. This impact may be referred to herein as the “mutual audibility” of audio devices. The mutual audibility will depend on various factors, including the positions and orientations of each audio device in the audio environment, the playback levels of each audio device, the loudspeaker capabilities of each audio device, etc. Some implementations may involve constructing a more precise representation of the mutual audibility of audio devices in an audio environment, such as an audibility matrix A representing the energy of the echo paths 200AA-200CC. For example, each column of the audibility matrix may represent an audio device loudspeaker and each row of the audibility matrix may represent an audio device microphone, or vice versa. In some such audibility matrices, the diagonal of the audibility matrix may represent the echo path from an audio device's loudspeaker(s) to the same audio device's microphone(s).

One can see from FIG. 2 that if 200CA and 200BA, which are the echo paths from audio devices 110C and 110B to audio device 100A, respectively, have a strong coupling then the echo from audio device 110C and audio device 110B will be significant in the echo (residual) of audio device 110A. In such instances, if the audio system's response to detecting the speech 102 (which in this example corresponds to a wakeword) is simply to turn the nearest loudspeaker down, this would involve ducking only the playback from loudspeaker(s) 121A. If this is the audio system's only response to detecting the wakeword, the potential SER improvement may be significantly limited. Accordingly, some disclosed examples may involve other responses to detecting a wakeword in such circumstances.

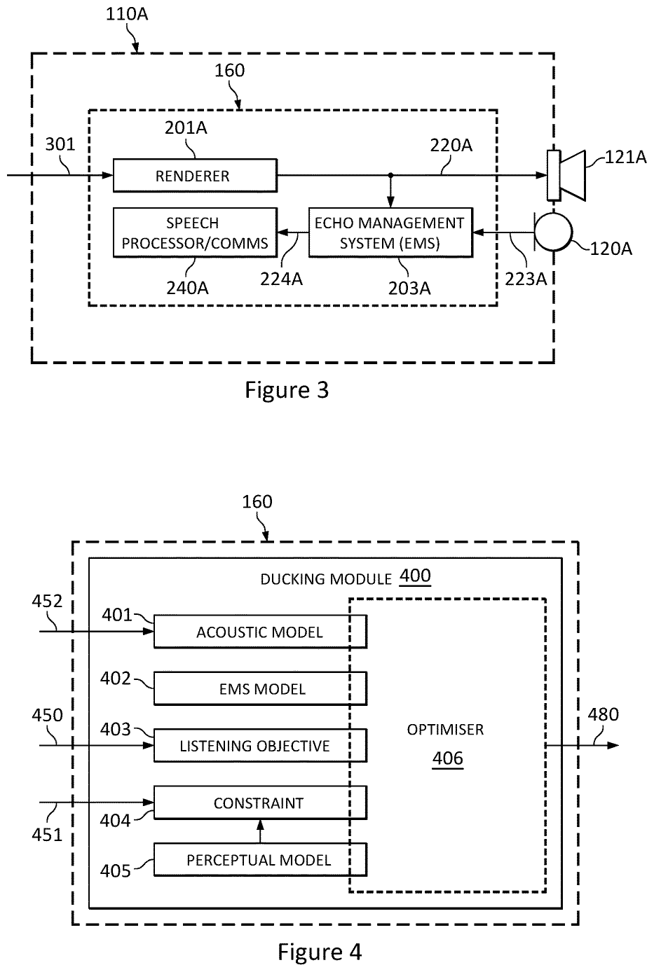

FIG. 3 is a system block diagram that represents components of audio devices according to one example. In FIG. 3, the block representing the audio device 110A includes a loudspeaker 121A and a microphone 120A. In some examples, the loudspeaker 121A may be one of a plurality of loudspeakers in a loudspeaker system, such as the loudspeaker system 175 of FIG. 1A. Similarly, according to some implementations the microphone 120A may be one of a plurality of microphones in a microphone system, such as the microphone system 170 of FIG. 1A.

In this example, the audio device 110A includes a renderer 201A, an echo management system (EMS) 203A and a speech processor/communications block 240A. In this example, the EMS 203A may be, or may include, an acoustic echo canceller (AEC), an acoustic echo suppressor (AES), or both an AEC and an AES. According to this example, the renderer 201A is configured to render audio data 301 received by the audio device 110A or stored on the audio device 110A for reproduction on loudspeaker 121A. In some examples, the audio data may include one or more audio signals and associated spatial data. The spatial data may, for example indicate an intended perceived spatial position corresponding to an audio signal. In some examples, the spatial data may be, or may include, spatial metadata corresponding to an audio object. In this example, the renderer output 220A is provided to the loudspeaker 121A for playback and the renderer output 220A is also provided to the EMS 203A as a reference for echo cancellation.

In addition to receiving the renderer output 220A, in this example the EMS 203A also receives microphone signals 223A from the microphone 120A. In this example, the EMS 203A processes the microphone signals 223A and provides the echo-canceled residual 224A (which also may be referred to herein as “residual output 224A”) to the speech processor/communications block 240A.

In some implementations, the speech processor/communications block 240A may be configured for speech recognition functionality. In some examples, the speech processor/communications block 240A may be configured to provide telecommunications services, such as telephone calls, video conferencing, etc. Although not shown in FIG. 3, the speech processor/communications block 240A may be configured for communication with one or more networks, the loudspeaker 121A and/or the microphone 120A, e.g., via an interface system. The one or more networks may, for example, include a local Wi-Fi network, one or more types of telephone networks, etc.

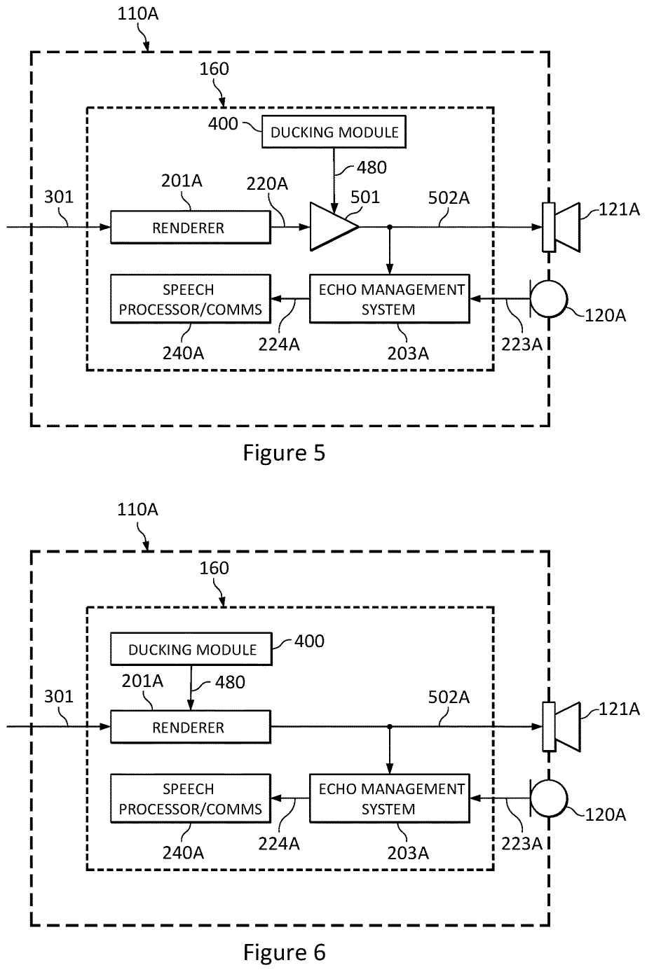

FIG. 4 shows elements of a ducking module according to one example. In this implementation, the ducking module 400 is implemented by an instance of the control system 160 of FIG. 1A. In this example, the elements of FIG. 4 are as follows:
401: an acoustic model of the inter-device and intra-device echo, which in some examples includes an acoustic model of user utterances. According to some examples, the acoustic model 401 may be, or may include, a model of how playback from each audio device in the audio environment presents itself as the echo detected by microphones of every audio device (itself and others) in the audio environment. In some examples, the acoustic model 401 may be based, at least in part, on audio environment impulse response estimates, characteristics of the impulse response, such as peak magnitude, decay time, etc. In some examples, the acoustic model 401 may be based, at least in part, on audibility estimates. In some such examples, the audibility estimates may be based on microphone measurements. Alternatively, or additionally, the audibility estimates may be inferred by the audio device positions, for example based on echo power being inversely proportional to the distance between audio devices. In some examples, the acoustic model 401 may be based, at least in part, on long-term estimates of the AEC/AES filter taps. In some examples, the acoustic model 401 may be based, at least in part, on the waffle, which may contain information on the capabilities (loudness) of each audio device's loudspeaker(s);
452: spatial information, which includes information regarding the position of each of a plurality of audio devices in the audio environment. In some examples, the spatial information 452 may include information regarding the orientation of each of the plurality of audio devices. According to some examples, the spatial information 452 may include information regarding the position of one or more people in the audio environment. In some instances, the spatial information 452 may include information regarding the impulse response of at least a portion of the audio environment;
402: a model of EMS performance, which may indicate the performance of the EMS 203A of FIG. 3 or the performance of another EMS (such as that of FIG. 5 or FIG. 6). In this example, the EMS performance model 402 predicts how well the EMS (AEC, AES, or both) will perform. In some examples, the EMS performance model 402 may predict how well the EMS will perform given the current audio environment impulse response, the current noise level(s) of the audio environment, the type of algorithm(s) being used to implement the EMS, the type of content being played back in the audio environment, the number of echo references being fed into the EMS algorithm(s), the capabilities/quality of loudspeakers in the audio environment (non-linearities in a loudspeaker will place an upper bound on expected performance), or combinations thereof. According to some examples, the EMS performance model 402 may be based, at least in part, on empirical observations, for example by observing how the EMS performs under various conditions, storing data points based on such observations and building a model (for example by fitting a curve) based on these data points. In some examples, the EMS performance model 402 may be based, at least in part, on machine learning, such as by training a neural network based on empirical observations of EMS performance. Alternatively, or additionally, the EMS performance model 402 may be based, at least in part, on a theoretical analysis of the algorithm(s) used by the EMS. In some examples, the EMS performance model 402 may indicate the ERLE (echo return loss enhancement) caused by operation of the EMS, which is a useful metric for evaluating EMS performance. The ERLE may, for example, indicate the amount of additional signal loss applied by the EMS between each audio device;
403: information regarding one or more current listening objectives. In some examples, the listening objective information 403 may set a target, such as an SER target or an SER improvement target, for the ducking module to achieve. According to some examples, the listening objective information 403 may include both spatial and level components;
450: target-related factors that may be used to determine the target, such as external triggers, acoustic events, mode indications, etc.;
404: one or more constraints to be applied during the process of determining a ducking solution, such as constraints that trade off improved listening performance (in other words, an improved ability of one or more microphones to capture audio, such as an utterance of a person) against other metrics (such as a degraded listening experience for a person in the audio environment). For example, in one example a constraint may prevent the ducking module 400 from reducing the loudspeaker reproduction level for some or all loudspeakers in the audio environment to an unacceptably low level, such as 0 decibels relative to full scale (dBFS);
451: metadata about the current audio content, which may include spatiality metadata, level metadata, content type metadata, etc. Such metadata may (directly or indirectly) provide information about the effect that ducking one or more loudspeakers would have on the listening experience of a person in the audio environment. For example, if the spatiality metadata indicates that a “large” audio object is being reproduced by multiple loudspeakers of the audio environment, ducking one of those loudspeakers may not have an objectionable impact on the listening experience. As another example, if the content metadata indicates that the content is a podcast, in some instances a monologue or dialogue of the podcast may be played back by multiple loudspeakers of the audio environment, so ducking one of those loudspeakers may not have an objectionable impact on the listening experience. However, if the content metadata indicates that the audio content corresponds to a movie or a television program, the dialogue of such content may be played back mainly or entirely by particular loudspeakers (such as “front” loudspeakers), so ducking those loudspeakers may have an objectionable impact on the listening experience;
405: a model used to derive perceptually-driven constraints. Some detailed examples are set forth elsewhere herein;
406: an optimization algorithm, which may vary according to the particular implementation. In some examples, the optimization algorithm 406 may be, or may include, a closed form optimization algorithm. In some instances, the optimization algorithm 406 may be, or may include, an iterative process. Some detailed examples are set forth elsewhere herein; and
480: the ducking solution output by the ducking module 400. As described in more detail elsewhere herein (such as with reference to FIGS. 5 and 6), the ducking solution 480 may differ according to various factors, including whether the ducking solution 480 is provided to a renderer or whether the ducking solution 480 is provided for audio data that has been output from a renderer.

According to some examples, the AEC model 402 and the acoustic model 401 may provide the means for estimating or predicting SER, e.g., as described below.

The constraint(s) 404 and the perceptual model 405 may be used to ensure that the ducking solution 480 that is output by the ducking module 400 is not degenerate or trivial. An example of a trivial solution would be to set the playback level to 0 globally. The constraint(s) 404 may be perceptual and/or objective. According to some examples, the constraint(s) 404 may be based, at least in part, on a perceptual model, such as a model of human hearing. In some examples, the constraint(s) 404 may be based, at least in part, on audio content energy preservation, audio spatiality preservation, an audio energy vector, or one or more combinations thereof. According to some examples, the constraint(s) 404 may be, or may include, a regularization constraint. The listening objective information 403 may, for example, determine the current target SER improvement to be made by way of distributed ducking (in other words, ducking two or more audio devices of the audio environment).

### Global Optimization

In some examples, the selection of the audio device(s) for ducking results in the estimated SER and/or wakeword information obtained when the wakeword was detected being used to select the audio device which will listen for the next utterance. If this audio device selection is wrong, then it is very unlikely that the best listening device will be able to understand the command spoken after the wakeword. This is because automatic speech recognition (ASR) is more difficult than wakeword detection (WWD), which is one of the motivating factors for ducking. If the best listening device was not ducked, then ASR is likely to fail on all of the audio devices. Thus, in some such examples, the ducking methodology involves using a prior estimate (from the WWD) to optimize the ASR stage by ducking the nearest (or best estimate) audio device(s).

Accordingly, some ducking implementations involve using a prior estimate when determining a ducking solution. However, in implementations such as that shown in FIG. 4, listening objectives and constraints can be applied to achieve a more robust ASR performance. In some such examples, the ducking methodology may involve configuring a ducking algorithm such that the SER improvement is significant and at all potential user locations in the acoustic space. In this way, we can ensure that at least one of the microphones in the room will have sufficient SER for a robust ASR performance. Such implementations may be advantageous if the talker's location is unknown, or if there is uncertainty regarding the talker's location. Some such examples may involve accounting for a variance in the talker and/or audio device position estimates by widening the SER improvement zone spatially to account for the uncertainty or uncertainties.

Some such examples may involve the use of the δ parameter of the following discussion, or a similar parameter. Other examples may involve multi-parameter models that describe, or correspond to, uncertainty in the talker position and/or audio device position estimates.

In some embodiments, the ducking methodology may be made in the context of one or more user zones. As detailed later in this document, a set of acoustic features

$$W ( j ) = {[ {w}_{1}^{T} ( j ) ... {w}_{N}^{T} ( j ) ]}^{T}$$

may be used to estimate posterior probabilities p(Zₖ|W(j)) for some set of zone labels Zₖ, for k={1 . . . K}, for K different user zones in an environment. An association of each audio device to each user zone may be provided by the user themselves as part of the training process described within this document, or alternatively through the means of an application, e.g., the Alexa smartphone app or the Sonos S2 controller smartphone app. For instance, some implementations may denote the association of the j^{th} device to the user zone with zone label Zₖ as z(Zₖ, n)∈[0, 1]. In some embodiments, both z(Zₖ, n) and the posterior probabilities p(Zₖ|W(j)) may be considered context information. Some embodiments may instead consider the acoustic features W(j) themselves to be part of the context. In other embodiments, more than one of these quantities (z(Zₖ, n), the posterior probabilities p(Zₖ|W(j)) and the acoustic features W(j) themselves) and/or a combination of these quantities may be part of the context information.

In some examples, the ducking methodology may use quantities related to one or more user zones in a process of selecting audio devices for ducking or other audio processing changes. Where both z and p are available, an example audio device selection decision might be made according to the following expression:

$${f}_{n} = {max}_{k} ( z ( {Z}_{k} , n ) {p ( {Z}_{k} \vert W ( j ) )}^{δ} \qquad k = \{ 1 ... K \}$$

According to some such embodiments, the audio devices with the highest association with the user zones most likely to contain the user (the talker) will have the most audio processing (e.g., rendering) change applied to them. In some examples, δ may be a positive number in the range [0.5, 4.0]. According to some such examples, δ may be used to control the scope of a rendering change spatially. In such implementations, if δ is chosen to be 0.5, more devices will receive a larger rendering change, whereas a value of 4.0 will restrict the rendering change to only the devices most proximate to the most likely user zone.

In some implementations, the acoustic features W(j) may be directly used in a ducking methodology. For instance, if the wakeword confidence scores associated with utterance j are wₙ(j), an audio device selection could be made according to the following expression:

$${f}_{n} = {( \frac{{w}_{n} ( j )}{{max}_{k} {w}_{k} ( j )} )}^{δ} \qquad k = \{ 1 ... K \}$$

In the foregoing expression, δ has the same interpretation as the previous example, and further has the utility of compensating for a typical distribution of wakeword confidences that might arise for a particular wakeword system. If most audio devices tend to report high wakeword confidences, δ can be selected to be a relatively higher number, such as 3.0, to increase the spatial specificity of the rendering change application. If wakeword confidence tends to fall off rapidly as the talker is located further away from the devices, δ can be chosen to be a relatively lower number such as 1.0 or even 0.5 in order to include more devices in the rendering change application. The reader will appreciate that in some alternative implementations, formulae similar to one above for acoustic features, such as an estimate of the speech level at the device's microphone, and/or the direct to reverb ratio of the user's utterance could be substituted for wakeword confidence.

FIG. 5 is a block diagram that shows an example of an audio device that includes a ducking module. The renderer 201A, the speech processor/communications block 240A, the EMS 203A, the loudspeaker(s) 121A and the microphone(s) 120A may function substantially as described with reference to FIG. 3, except as noted below. In this example, the renderer 201A, the speech processor/communications block 240A, the EMS 203A and the ducking module 400 are implemented by an instance of the control system 160 that is described with reference to FIG. 1A. The ducking module 400 may, for example, be an instance of the ducking module 400 that is described with reference to FIG. 4. Accordingly, the ducking module 400 may be configured to determine one or more types of audio processing changes (indicated by, or corresponding to, the ducking solution 480) to apply to rendered audio data (such as audio data that has been rendered to loudspeaker feed signals) for at least the audio device 110A. The audio processing changes may be, or may include, a reduction in a loudspeaker reproduction level for one or more loudspeakers in the audio environment. In some examples, the ducking module 400 may be configured to determine one or more types of audio processing changes to apply to rendered audio data two or more audio devices in the audio environment.

In this example, the renderer output 220A and the ducking solution 480 are provided to the gain multiplier 501. In some examples, the ducking solution 480 includes gains for the gain multiplier 501 to apply to the renderer output 220A, to produce the processed audio data 502. According to this example, the processed audio data 502 is provided to the EMS 203A as a local reference for echo cancellation. Here, the processed audio data 502 is also provided to the loudspeaker(s) 121A for reproduction.

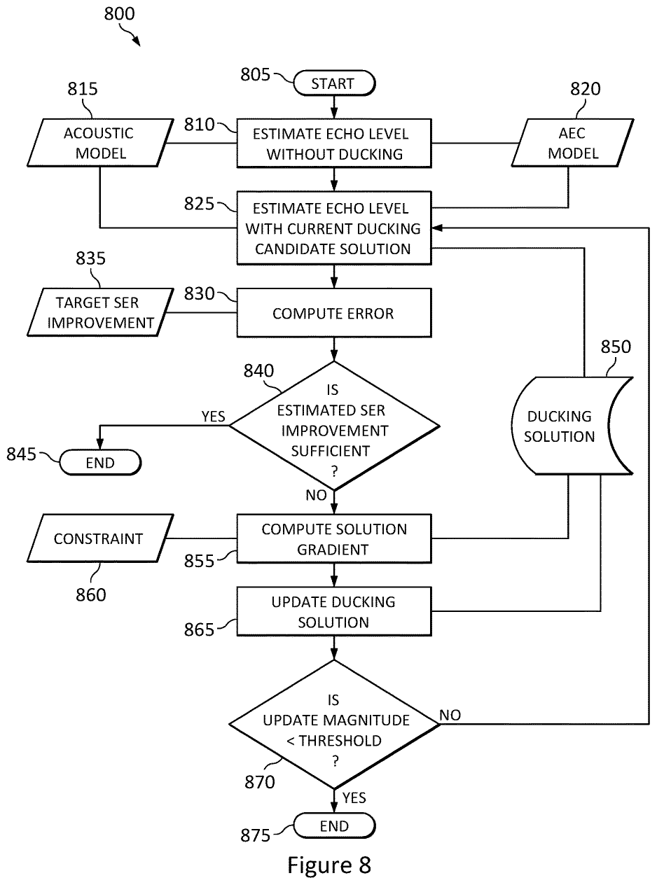

In some examples, the ducking module 400 may be configured to determine the ducking solution 480 as described below with reference to FIG. 8. According to some examples, the ducking module 400 may be configured to determine the ducking solution 480 as described below in the “Optimizing for a Particular Device” section.

FIG. 6 is a block diagram that shows an alternative example of an audio device that includes a ducking module. The renderer 201A, the speech processor/communications block 240A, the EMS 203A, the loudspeaker(s) 121A and the microphone(s) 120A may function substantially as described with reference to FIG. 3, except as noted below. The ducking module 400 may, for example, be an instance of the ducking module 400 that is described with reference to FIG. 4. In this example, the renderer 201A, the speech processor/communications block 240A, the EMS 203A and the ducking module 400 are implemented by an instance of the control system 160 that is described with reference to FIG. 1A.

According to this example, the ducking module 400 is configured to provide the ducking solution 480 to the renderer 201A. In some such examples, the ducking solution 480 may cause the renderer 201A to implement one or more types of audio processing changes, which may include a reduction in loudspeaker reproduction level, during the process of rendering the received audio data 301 (or during the process of rendering audio data that has been stored in a memory of the audio device 110A. In some examples, the ducking module 400 may be configured to determine a ducking solution 480 for implementation of one or more types of audio processing changes via one or more instances of the renderer 201A in one or more other audio devices in the audio environment.

In this example, the renderer output 201A outputs the processed audio data 502. According to this example, the processed audio data 502 is provided to the EMS 203A as a local reference for echo cancellation. Here, the processed audio data 502 is also provided to the loudspeaker(s) 121A for reproduction.

In some examples, the ducking solution 480 may include one or more penalties that are implemented by a flexible rendering algorithm, e.g., as described below. In some such examples, the penalties may be loudspeaker penalties that are estimated to cause a desired SER improvement. According to some examples, determining the one or more types of audio processing changes may be based on the optimization of a cost function by the ducking module 400 or by the renderer 201A.

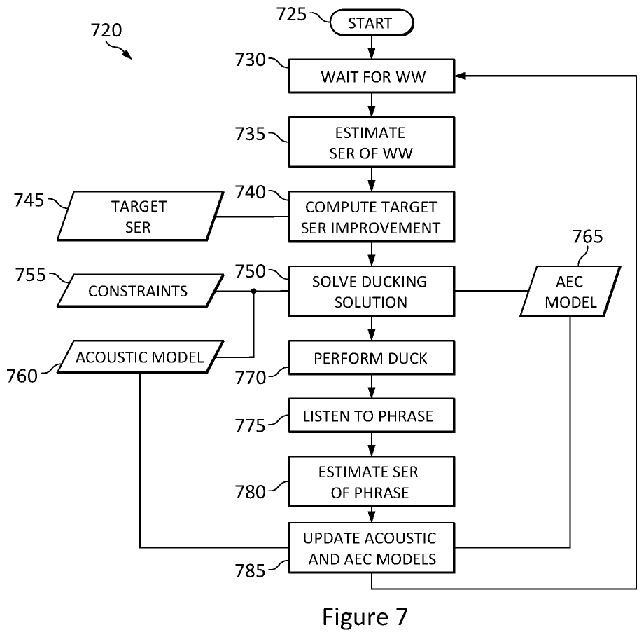

FIG. 7 is a flow diagram that outlines one example of a method for determining a ducking solution. In some examples, method 720 may be performed by an apparatus such as that shown in FIG. 1A, FIG. 5 or FIG. 6. In some examples, method 720 may be performed by a control system of an orchestrating device, which may in some instances be an audio device. In some examples, method 720 may be performed, at least in part, by a ducking module, such as the ducking module 400 of FIG. 4, FIG. 5 or FIG. 6. According to some examples, method 720 may be performed, at least in part, by a renderer. The blocks of method 720, like other methods described herein, are not necessarily performed in the order indicated. Moreover, such methods may include more or fewer blocks than shown and/or described.

In this example, the process starts with block 725. In some instances, block 725 may correspond with a boot-up process, or a time at which a boot-up process has completed and a device that is configured to perform the method 720 is ready to function.

According to this example, block 730 involves waiting for a wakeword to be detected. If method 720 is being performed by an audio device, block 730 also may involve playing back rendered audio data corresponding to received or stored audio content, such as musical content, a podcast, an audio soundtrack for a movie or a television program, etc.

In this example, upon detecting a wakeword (e.g., in block 730), an SER of the wakeword is estimated in block 735. S(a) is an estimate of the speech-to-echo ratio at a device a. By definition, the speech to echo ratio in dB is given by:

$$S ( a ) = \text{?} - \text{?}$$

In the foregoing expression, [symbol] represents an estimate of the speech energy in dB, and [symbol] represents an estimate of the residual echo energy after echo cancellation, in dB. Various methodologies for estimating these quantities are disclosed herein, for example:
(1) Speech energy and residual echo energy may be estimated by an offline measurement process performed for a particular device, taking into consideration the acoustic coupling between the device's microphone and speakers, and performance of the on-board echo cancellation circuitry. In some such examples, an average speech energy level “AvgSpeech” may be determined by the average level of human speech as measured by the device at a nominal distance. For example, speech from a small number of people standing 1 m away from a microphone-equipped device may be recorded by the device during production and the energy may be averaged to produce AvgSpeech. According to some such examples, an average residual echo energy level “AvgEcho” may be estimated by playing music content from the device during production and running the on-board echo cancellation circuitry to produce an echo residual signal. Averaging the energy of the echo residual signal for a small sample of music content may be used to estimate AvgEcho. When the device is not playing audio, AvgEcho may be instead set to a nominal low value, such as −96.0 dB. In some such implementations, speech energy and residual echo energy may be expressed as follows:

$$\text{?} = {AvgSpeech}_{dB}$$

$$\text{?} = {AvgEcho}_{dB}$$

(2) According to some examples, the average speech energy may be determined by taking the energy of the microphone signals corresponding to a user's utterance as determined by a voice-activity-detector (VAD). In some such examples, the average residual echo energy may be estimated by the energy of the microphone signals when the VAD is not indicating speech. If x represents device a's microphone pulse-code modulation (PCM) samples at some sampling rate, and V represents the VAD flag taking the value 1.0 for samples corresponding to voice activity, and 0.0 otherwise, speech energy and residual echo energy may be expressed as follows:

$$\text{?} = 10 * log 10 ( {\sum }_{n} V [ n ] {x [ n ]}^{2} )$$

$$\text{?} = 10 * log 10 ( {\sum }_{n} ( 1 - V [ n ] ) {x [ n ]}^{2} )$$

(3) Further to the previous methods, in some implementations the energy in the microphone may be treated as a random variable and modelled separately based on the VAD determination. Statistical models Sp and E of the speech and echo energy respectively can be estimated using any number of statistical modelling techniques. Mean values in dB for both speech and echo for approximating S(a) may then be drawn from Sp and E respectively. Common methods of achieving this are found within the field of statistical signal processing, for example:
Assuming a Gaussian distribution of energy and computing biased second order statistics \hat{μ} and \hat{σ}.
Building a discretely-binned histogram of energy values to yield a potentially multimodal distribution, which after applying a step of expectation-maximization (EM) parameter estimation for a mixture model (e.g., a Gaussian mixture model), the largest mean value \hat{μ} belonging to any of the sub-distributions in the mixture may be used.

According to this example, block 740 involves obtaining a target SER (from block 745, in this instance) and computing a target SER improvement. In some implementations, a desired SER improvement (SERI) may be determined as follows:

$$SERI = S ( m ) - TargetSER [ dB ]$$

In the foregoing expression, m represents the device/microphone location for which an SER is being improved, and TargetSER represents a threshold, which in some examples may be set according to the application in use. For instance, a wakeword detection algorithm may tolerate a lower operating SER than a command detection algorithm, and a command detection algorithm may tolerate a lower operating SER than a large vocabulary speech recognizer. Typical values for a TargetSER may be in the order of −6 dB to 12 dB. If in some instances S (m) is not known or is not easily estimated, a pre-set value may suffice based on offline measurements of speech and echo recorded in a typical echoic room or setting. Some embodiments may determine the audio devices for which audio processing (e.g., rendering) is to be modified by specifying f_n ranging from 0 to 1. Other embodiments may involve specifying the degree to which audio processing (e.g., rendering) should be modified in units of speech to echo ratio improvement decibels, Sn (also represented herein as s_n), potentially computed according to:

$${s}_{n} = SERI * {f}_{n}$$

Some embodiments may compute f_n directly from the device geometry, e.g., as follows:

$${f}_{n} = 1 - {( \frac{H ( m , n )}{{max}_{i ∈ D} H ( m , i )} )}^{2}$$

In the foregoing expression, m represents the index of the device that will be selected for the largest audio processing (e.g., rendering) modification and H(m, i) represents the approximate physical distance between devices m and i. Other implementations may involve other choices of easing or smoothing functions over the device geometry.

Accordingly, H is a property of the physical location of the audio devices in the audio environment. H may be determined or estimated according to various methods, depending on the particular implementation. Various examples of methods for estimating the location of audio devices in an audio environment are described below.

In this example, block 750 involves calculating what may be referred to herein as a “ducking solution.” Although a ducking solution may involve determining a reduction of loudspeaker reproduction level for one or more loudspeakers in the audio environment, the ducking solution also may involve one or more other audio processing changes such as those disclosed herein. The ducking solution that is determined in block 750 is one example of the ducking solution 480 of FIGS. 4, 5 and 6. Accordingly, block 750 may be performed by the ducking module 400.

According to this example, the ducking solution that is determined in block 750 is based (at least in part) on the target SER, on ducking constraints (represented by block 755), on an AEC Model (represented by block 765) and on an acoustic model (represented by block 760). The acoustic model may be an instance of the acoustic model 401 of FIG. 4. The acoustic model may, for example, be based at least in part on inter-device audibility, which may also be referred to herein as inter-device echo or mutual audibility. The acoustic model may, in some examples, be based at least in part on intra-device echo. In some instances, the acoustic model may be based at least in part on an acoustic model of user utterances, such as acoustic characteristics of typical human utterances, acoustic characteristics of human utterances that have previously been detected in the audio environment, etc. The AEC model may, in some examples, be an instance of the AEC model 402 of FIG. 4. The AEC model may indicate the performance of the EMS 203A of FIG. 5 or FIG. 6. In some examples, the EMS performance model 402 may indicate an actual or expected ERLE (echo return loss enhancement) caused by operation of the AEC. The ERLE may, for example, indicate the amount of additional signal loss applied by the AEC between each audio device. According to some examples, the EMS performance model 402 may be based, at least in part, on an expected ERLE for a given number of echo references. In some examples, the EMS performance model 402 may be based, at least in part, on an estimated ERLE computed from actual microphone and residual signals.

In some examples, the ducking solution that is determined in block 750 may be an iterative solution, whereas in other examples the ducking solution may be a closed form solution. Examples of both iterative solutions and closed form solutions are disclosed herein.

In this example, block 770 involves applying the ducking solution determined in block 750. In some examples, as shown in FIG. 5, the ducking solution may be applied to rendered audio data. In other examples, as shown in FIG. 6, the ducking solution determined in block 750 may be provided to a renderer. The ducking solution may be applied as part of process of rendering audio data input to the renderer.

In this example, block 775 involves detecting another utterance, which may in some examples be a command that is uttered after a wakeword. According to this example, block 780 involves estimating an SER of the utterance detected in block 775. In this example, block 785 involves updating the AEC model and the acoustic model based, at least in part, on the SER estimated in block 780. According to this example, the process of block 785 is done after the ducking solution is applied. In a perfect system, the actual SER improvement and the actual SER would be exactly what was targeted. In a real-world system, the actual SER improvement and the actual SER are likely to be different from what was targeted. In such implementations, method 720 involves using at least the SER to update information and/or models that were used to compute the ducking solution. According to this example, the ducking solution is based at least in part on the acoustic model of block 760. For example, the acoustic model of block 760 may have indicated a very strong acoustic coupling between audio device X and microphone Y, and consequently the ducking solution may have involved ducking signals from microphone Y to a large degree. However, after estimating the SER of the utterance detected in block 775 while the ducking solution was being applied, a control system may have determined that the actual SER and/or SERI were not what was expected. If so, block 785 may involve updating the acoustic model accordingly (in this example, by reducing the acoustic coupling estimate between audio device X and microphone Y). According to this example, the process then reverts to block 730.

FIG. 8 is a flow diagram that outlines another example of a method for determining a ducking solution. In some examples, method 800 may be performed by an apparatus such as that shown in FIG. 1A, FIG. 5 or FIG. 6. In some examples, method 800 may be performed by a control system of an orchestrating device, which may in some instances be an audio device. In some examples, method 800 may be performed, at least in part, by a ducking module, such as the ducking module 400 of FIG. 4, FIG. 5 or FIG. 6. According to some examples, method 800 may be performed, at least in part, by a renderer. The blocks of method 800, like other methods described herein, are not necessarily performed in the order indicated. Moreover, such methods may include more or fewer blocks than shown and/or described.

In this example, the process starts with block 805. In some instances, block 805 may correspond with a boot-up process, or a time at which a boot-up process has completed and a device that is configured to perform the method 800 is ready to function.

According to this example, block 810 involves estimating the current echo level without the application of a ducking solution. In this example, block 810 involves estimating the current echo level based (at least in part) on an acoustic model (represented by block 815) and on an AEC model (represented by block 820). Block 810 may involve estimating the current echo level that will result from a current ducking candidate solution. The estimated current echo level may, in some examples, be combined with a current speech level to produce an estimated current SER improvement.

The acoustic model may be an instance of the acoustic model 401 of FIG. 4. The acoustic model may, for example, be based at least in part on inter-device audibility, which may also be referred to herein as inter-device echo or mutual audibility. The acoustic model may, in some examples, be based at least in part on intra-device echo. In some instances, the acoustic model may be based at least in part on an acoustic model of user utterances, such as acoustic characteristics of typical human utterances, acoustic characteristics of human utterances that have previously been detected in the audio environment, etc.

The AEC model may, in some examples, be an instance of the AEC model 402 of FIG. 4. The AEC model may indicate the performance of the EMS 203A of FIG. 5 or FIG. 6. In some examples, the EMS performance model 402 may indicate an actual or expected ERLE (echo return loss enhancement) caused by operation of the AEC. The ERLE may, for example, indicate the amount of additional signal loss applied by the AEC between each audio device. According to some examples, the EMS performance model 402 may be based, at least in part, on an expected ERLE for a given number of echo references. In some examples, the EMS performance model 402 may be based, at least in part, on an estimated ERLE computed from actual microphone and residual signals.

According to this example, block 825 involves obtaining a current ducking solution (represented by block 850) and estimating an SER based on applying the current ducking solution. In some examples, the ducking solution may be determined as described with reference to block 750 of FIG. 7.

In this example, block 830 involves computing the difference or “error” between the current estimate of the SER improvement and a target SER improvement (represented by block 835). In some alternative examples, block 830 may involve computing the difference between the current estimate of the SER and a target SER.

Block 840, in this example, involves determining whether the difference or “error” computed in block 830 is sufficiently small. For example, block 840 may involve determining whether the difference computed in block 830 is equal to or less than a threshold. The threshold may, in some examples, be in the range of 0.1 dB to 1.0 dB, such as 0.1 dB, 0.2 dB, 0.3 dB, 0.4 dB, 0.5 dB, 0.6 dB, 0.7 dB, 0.8 dB, 0.9 dB or 1.0 dB. In such examples, if it is determined in block 840 that the difference computed in block 830 is equal to or less than the threshold, the process ends in block 845. The current ducking solution may be output and/or applied.

However, if it is determined in block 840 that the difference computed in block 830 is not sufficiently small (for example, is not equal to a threshold or less than the threshold), the process continues to block 855 in this example. According to this example, the ducking solution is, or includes, a ducking vector. In this example, block 855 involves computing the gradient of a cost function and a constraint function with respect to the ducking vector. The cost function may, for example, correspond to (or describe) the error between the estimated SER improvement and the target SER improvement, as determined in block 830.

In some implementations, the constraint function may penalize the impact of the ducking vector against one or more objective functions (for example, an audio energy preservation function), one or more subjective functions (such as one or more perceptual-based functions), or a combination thereof. In some such examples, one or more of the constraints may be based on a perceptual model of human hearing. According to some examples, one or more of the constraints may be based on audio spatiality preservation.

In some examples, block 855 may involve optimizing a cost that is a function of a model of perceived spatial position of the audio signal played when played back over the set of loudspeakers in the environment and a measure of proximity of the intended perceived spatial position of the audio signal to a position of each loudspeaker of the set of loudspeakers. In some such examples, the cost may be a function of one or more additional dynamically configurable functions. In some such examples, at least one of the one or more additional dynamically configurable functions corresponds to echo canceler performance. According to some such examples, at least one of the one or more additional dynamically configurable functions corresponds to the mutual audibility of loudspeakers in the audio environment. Detailed examples are provided below. However, other implementations may not involve these types of cost functions.

According to this example, block 865 involves updating the current ducking solution using the gradient and one or more types of optimizers, such as the algorithm below, stochastic gradient descent, or another known optimizer.

In this example, block 870 involves evaluating the change in the ducking solution from the previous ducking solution. According to this example, if it is determined in block 870 that the change in the ducking solution from the previous solution is less than a threshold, the process ends in block 875. According to some examples, the threshold may be expressed in decibels. According to some such examples, the threshold may be in the range of 0.1 dB to 1.0 dB, such as 0.1 dB, 0.2 dB, 0.3 dB, 0.4 dB, 0.5 dB, 0.6 dB, 0.7 dB, 0.8 dB, 0.9 dB or 1.0 dB. In some examples, if it is determined in block 870 that the change in the ducking solution from the previous solution is less than or equal to the threshold, the process ends.

However, in this example, if it is determined in block 870 that the change in the ducking solution from the previous solution is not less than the threshold, the ducking solution of block 850 is updated to be the current ducking solution and the process reverts to block 825. In some examples, method 800 may continue until block 845 or block 875 is reached. According to some examples, method 800 may terminate if block 845 or block 875 is not reached within a time interval or within a number of iterations.

After method 800 ends, the resulting ducking solution may be applied. In some examples, as shown in FIG. 5, the ducking solution may be applied to rendered audio data. In other examples, as shown in FIG. 6, the ducking solution determined via method 800 may be provided to a renderer. The ducking solution may be applied as part of process of rendering audio data input to the renderer. However, as noted elsewhere herein, in some implementations method 800 may be performed, at least in part, by a renderer. According to some such implementations, the renderer may both determine and apply the ducking solution.

The algorithm below is an example of obtaining a ducking solution. In some examples, the ducking solution may be, include or indicate gains to be applied to rendered audio data. Accordingly, in some such examples the ducking solution may be appropriate for a ducking module 400 such as that shown in FIG. 5.

The following symbols are defined as indicated below:
A represents a mutual audibility matrix (the audibility between each audio device);
P represents a nominal (not ducked) playback level vector (across audio devices);
D represents a ducking solution vector (across devices), which may correspond to the ducking solution 480 output by the ducking module 400; and.
C represents the AEC performance matrix, which in this example indicates ERLE (echo return loss enhancement), the amount of additional signal loss applied by the AEC between each audio device.

The net echo in the microphone feed of audio device i may be represented as follows:

$${E}_{mic , i} = {\sum }_{j}^{J} {( {A}_{j}^{i} {P}_{j} )}^{2} \qquad ( 1 )$$

In Equation 1, J represents the number of audio devices in the room,

$${A}_{j}^{i}$$

represents the audibility of audio device j to audio device i and Pⱼ represents the playback level of audio device j. If we then consider the impact of ducking any of the audio devices, the echo in the microphone feed may be represented as follows:

$${E}_{mic , i} = {\sum }_{j}^{J} {( {A}_{j}^{i} {P}_{j} {D}_{j} )}^{2} \qquad ( 2 )$$

In Equation 2, Dⱼ represents the ducking gain. If we also consider a naive model of the AEC, where a nominal ERLE is applied to each speaker render independently, then we can express the echo power in the residual as follows:

$${E}_{mic , i} = {\sum }_{j}^{J} {( {A}_{j}^{i} {P}_{j} {D}_{j} {C}_{j}^{i} )}^{2} \qquad ( 3 )$$

In Equation 3,

$${C}_{j}^{i}$$

represents the ability of audio device i to cancel the echo from audio device j. In some examples, it will be assumed that

$${C}_{j}^{i}$$

is either −20 dB or 0 dB due to the AEC either including or not including that reference for cancellation.

Producing C can be as trivial as setting the entries to be nominal cancellation performance values if a particular device is performing cancellation for that particular non-local (“far”) device entry in the C matrix. More complicated models may account for audio environment adaption noise (any noise in the adaptive filter process) and the cross-channel correlation. For example, such models may predict how the AEC would perform in the future if a given ducking solution were applied. Some such models may be based, at least in part, on the echo level and noise level of the audio environment.

In this example, the distributed ducking problem is formulated as an optimization problem that involves minimizing the total echo power in the AEC residual by varying the ducking vector, which may be expressed as follows:

$${min}_{D} {\sum }_{j}^{J} {A}_{j}^{i} {P}_{j} {D}_{j} {C}_{j}^{i} \qquad ( 4 )$$

Being unconstrained, the formulation of Equation 4 will drive each audio device to duck to 0 dBFS. Therefore, some examples introduce a constraint that trades off the improvement in SER against negative impacts on the listening experience. Some such examples take into account the magnitude of the loudspeaker renders without changing the covariance. This constrained problem can be written as follows:

$${min}_{D} ( {\sum }_{j}^{J} {( {A}_{j}^{i} {P}_{j} {D}_{j} {C}_{j}^{i} )}^{2} + λ g ( {A}^{L} , P , D ) ) \qquad ( 5 )$$

In Equation 5, λ represents a Lagrange multiplier that weights the listener's experience over the improvement in SER, A^{L} represents the audibility of each device at the listener's position and g( ) represents one possible constraint function. Various constraint functions may be used in the process of determining a ducking solution. Another constraint function may be expressed as follows:

$$g ( P , D ) = {\sum }_{j}^{J} {( {P}_{j} )}^{2} - {\sum }_{j}^{J} {( {P}_{j} {D}_{j} )}^{2} \qquad ( 6 )$$

which gives a simple gradient of:

$$\frac{\partial g ( P , D )}{\partial D} = - 2 {D}^{T} {P}^{2} \qquad ( 7 )$$

### Iterative Ducking Solutions

In one example, a gradient-based iterative solution to the distributed ducking optimization problem may take the following form:

$${D}^{n + 1} = {D}^{n} + μ ∇ F \qquad ( 8 )$$

In Equation 8, F represents a cost function that describes the distributed ducking problem and Dⁿ represents a ducking vector at the n^{th} iteration. With this form, we are constrained to D∈[0,1]. However, even with the addition of regularization terms to Equation 8, we are not guaranteed that D∈[0,1] without adding in some heuristics and/or hard constraints. Another approach involves formulating a gradient-based iterative ducking solution as follows:

$${D}^{n + 1} = {D}^{n} Z \qquad ( 9 )$$

In some examples, Z∈[0,1]. However, if one desires to improve the SER at audio device i by way of reducing the echo power in the microphone feed of audio device i, whilst also maintaining the perceived quality of the audio content being rendered (at least to some degree), then one may see that one only needs to ensure D≥0 and Z≥0. This implies that we to allow some audio devices to boost their full-band volume in order to maintain the quality of rendered content, at least to some degree. Accordingly, in some examples Z may be defined as follows:

$$Z = exp \{ F + R \} \qquad ( 10 )$$

In Equation 10, F represents a cost function describing the distributed ducking problem and R is a regularization term that aims to maintain the quality of the rendered audio content. In some examples, R may be an energy preservation constraint. The regularization term R also may allow sensible solutions for D to be found.

If we consider T to be a target SER improvement at audio device i by way of ducking audio devices in an audio environment, then we can define F as follows:

$$F = 1 - T \frac{{E}_{res , i}^{n}}{{E}_{res , i}^{0}} \qquad ( 11 )$$

In Equation 11,

$${E}_{res , i}^{n}$$

represents the echo in the residual of device i at the n^{th} iteration evaluated using Equation 3, while

$${E}_{res , i}^{0}$$

represents the echo in the residual of device i when D is all ones. However, defining F as shown in Equation 11 will result in the step size being a function of T as well as the error. In some examples, F may be reformulated as follows to remove the dependence on the target SER:

$$F = \frac{1 - T \frac{{E}_{res , i}^{n}}{- 1 {E}_{res , i}^{0}}}{T - 1} \qquad ( 12 )$$

It is potentially advantageous to adjust each element of the ducking vector proportionally to the sensitivity of E with respect to each element. Moreover, it is potentially advantageous to allow the user to have some control over the step size. With these goals in mind, in some examples F may be reformulated as follows:

$$F = \frac{μ M ( 1 - T \frac{{E}_{res , i}^{n}}{{E}_{res , i}^{0}} )}{T - 1} \qquad ( 13 )$$

In Equation 13, M scales the individual contribution of each device to the echo in audio device i's residual. In some examples, M may be expressed as follows:

$$\begin{matrix}{M}^{′} = {A}^{i} ⊙ {C}^{i} ⊙ P & M = \frac{{M}^{′}}{{‖ {M}^{′} ‖}_{∞}}\end{matrix} \qquad ( 14 )$$

In Equation 14, ⊙ represents the Hadamard product. According to some examples, scaling by the square root of Equation 14 may produce acceptable (or even improved) results. In some examples, a regularization term R may be expressed as follows:

$$R = λ ( 1 - D ) \qquad ( 15 )$$

In Equation 15, λ represents the Lagrange multiplier. Equation 15 allows a control system to find a concise solution for D. However, in some examples a ducking solution may be determined that maintains an acceptable listening experience and preserves the total energy in the audio environment by defining the regularization term R as follows:

$$R = \frac{P λ ( 1 - D )}{{‖ P ‖}_{1}} \qquad ( 16 )$$

### Ducking Solver Algorithm

With the foregoing discussion in mind, the following ducking solver algorithm may be readily understood. The following algorithm is an example of method 800 of FIG. 8.

```
Input: A: audibility matrix (magnitude)
      C cancellation matrix (magnitude)
      P: playback levels vector (magnitude)
      T: target SER improvement magnitude
      J: number of audio devices i: audio device to optimize
      ducking for
Output: D: ducking vector (magnitude)
${E}^{0} = {\sum }_{j}^{J} {( {A}_{j}^{i} {P}_{j} {D}_{j} {C}_{j}^{i} )}^{2}$
D = 1's (vector of all 1s)
M′ = Aⁱ ⊙ Cⁱ ⊙ P
M = M′/max (M′)
not_converged = True
While not_converged do
  $1. \qquad {E}^{n} = {\sum }_{j}^{J} {( {A}_{j}^{i} {P}_{j} {D}_{j}^{n} {C}_{j}^{i} )}^{2}$
  $2. \qquad F = \frac{μ M ( 1 - {T}_{{E}^{0}}^{{E}^{n}} )}{T - 1}$
  3. if preserve_energy
    $a . \qquad then : R = \frac{P λ ( 1 - D )}{{‖ P ‖}_{1}}$
    b. Else: R = λ(1 − D)
  4. Dⁿ⁺¹ = Dⁿ exp {F + R}
  5. if||Dⁿ⁺¹ − Dⁿ ||₂ < THRESHthen
    a. not_converged = False
```

According to some such examples, THRESH (a threshold) may be 6 dB, 8 dB, 10 dB, 12 dB, 14 dB, etc.

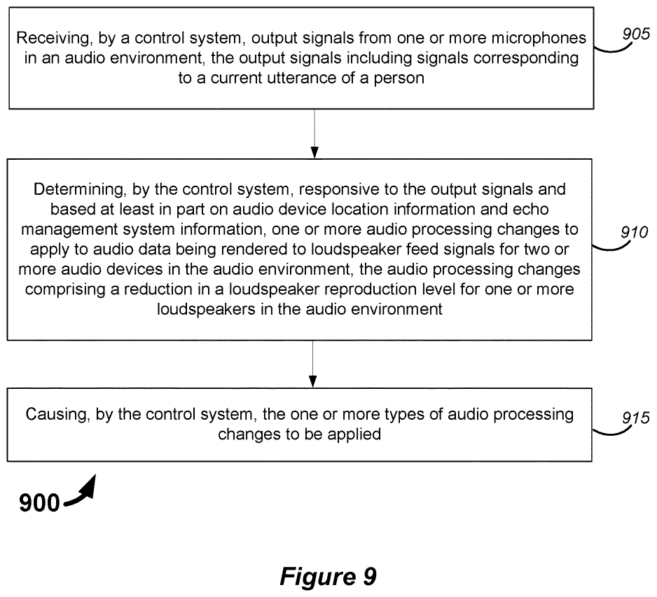

FIG. 9 is a flow diagram that outlines an example of a disclosed method. In some examples, method 900 may be performed by an apparatus such as that shown in FIG. 1A, FIG. 5 or FIG. 6. In some examples, method 900 may be performed by a control system of an orchestrating device, which may in some instances be an audio device. In some examples, method 900 may be performed, at least in part, by a ducking module, such as the ducking module 400 of FIG. 4, FIG. 5 or FIG. 6. According to some examples, method 900 may be performed, at least in part, by a renderer. The blocks of method 900, like other methods described herein, are not necessarily performed in the order indicated. Moreover, such methods may include more or fewer blocks than shown and/or described.

In this example, block 905 involves receiving, by a control system, output signals from one or more microphones in an audio environment. Here, the output signals include signals corresponding to a current utterance of a person. In some instances, the current utterance may be, or may include, a wakeword utterance.

According to this example, block 910 involves determining, by the control system, responsive to the output signals and based at least in part on audio device location information and echo management system information, one or more audio processing changes to apply to audio data being rendered to loudspeaker feed signals for two or more audio devices in the audio environment. In this example, the audio processing changes include a reduction in a loudspeaker reproduction level for one or more loudspeakers in the audio environment. Accordingly, the audio processing changes may include, or may be indicated by, what is referred to herein as a ducking solution. According to some examples, at least one of the one or more types of audio processing changes may correspond with an increased signal to echo ratio.

However, in some examples the audio processing changes may include, or involve, changes other than a reduction in a loudspeaker reproduction level. For example, the audio processing changes may involve shaping the spectrum of the output of one or more loudspeakers, which also may be referred to herein as “spectral modification” or “spectral shaping.” Some such examples may involve shaping the spectrum with a substantially linear equalization (EQ) filter that is designed to produce an output that is different from the spectrum of the audio that we wish to detect. In some examples, if the output spectrum is being shaped in order to detect a human voice, a filter may turn down frequencies in the range of approximately 500-3 kHz (e.g., plus or minus 5% or 10% at each end of the frequency range). Some examples may involve shaping the loudness to emphasize low and high frequencies, leaving space in the middle bands (e.g., in the range of approximately 500-3 kHz).

Alternatively, or additionally, in some examples the audio processing changes may involve changing the upper limits or peaks of the output to lower the peak level and/or reduce distortion products that may additionally lower the performance of any echo cancellation that is part of the overall system creating the achieved SER for audio detection, e.g., via a time domain dynamic range compressor or a multiband frequency-dependent compressor. Such audio signal modifications can effectively reduce the amplitude of an audio signal and can help limit the excursion of a loudspeaker.

Alternatively, or additionally, in some examples the audio processing changes may involve spatially steering the audio in a way that would tend to decrease the energy or coupling of the output of the one or more loudspeakers to one or more microphones at which the system (e.g., an audio processing manager) is enabling a higher SER. Some such implementations may involve the “warping” examples that are described herein.

Alternatively, or additionally, in some examples the audio processing changes may involve the preservation of energy and/or creating continuity at a specific or broad set of listening locations. In some examples, energy removed from one loudspeaker may be compensated for by providing additional energy in or to another loudspeaker. In some instances, the overall loudness may remain the same, or essentially the same. This is not an essential feature, but may be an effective means of allowing more severe changes to the ‘nearest’ device's, or nearest set of devices', audio processing without the loss of content. However, continuity and/or preservation of energy may be particularly relevant when dealing with complex audio output and audio scenes.

Alternatively, or additionally, in some examples the audio processing changes may involve time constants of activation. For example, changes to audio processing may be applied a bit faster (e.g., 100-200 ms) than they are returned to the normal state (e.g., 1000-10000 ms) such that the change(s) in audio processing, if noticeable, seems deliberate, but the subsequent return from the change(s) may not seem to relate to any actual event or change (from the user's perspective) and, in some instances, may be slow enough to be barely noticeable.

In this example, block 915 involves causing, by the control system, the one or more types of audio processing changes to be applied. In some examples, such as that shown in FIG. 5, the audio processing changes may be applied to rendered audio data according to a ducking solution 480 from a ducking module 400. According to some examples, such as that shown in FIG. 5, the audio processing changes may be applied by a renderer. In some such examples, the one or more types of audio processing changes may involve changing a rendering process to warp a rendering of audio signals away from the estimated location of the person. However, in some such examples, such audio processing changes may nonetheless, based at least in part on a ducking solution 480 from a ducking module 400.

According to some examples, the echo management system information may include a model of echo management system performance. In some examples, the model of echo management system performance may be, or may include, an acoustic echo canceller (AEC) performance matrix. In some examples, the model of echo management system performance may be, or may include, a measure of expected echo return loss enhancement provided by an echo management system.

In some examples, the one or more types of audio processing changes may be based at least in part on an acoustic model of inter-device echo and intra-device echo. Alternatively, or additionally, in some examples the one or more types of audio processing changes may be based at least in part on a mutual audibility matrix.

Alternatively, or additionally, in some examples the one or more types of audio processing changes may be based at least in part on an estimated location of the person. In some examples, the estimated location may correspond with a point, whereas in other examples the estimated location may correspond with an area, such as a user zone. According to some such examples, the user zone may be a portion of the audio environment, such as a couch area, a table area, a chair area, etc. In some examples, the estimated location may correspond with an estimated location of the person's head. According to some examples, the estimated location of the person may be based, at least in part, on output signals from a plurality of microphones in the audio environment.

In some implementations, the one or more types of audio processing changes may be based, at least in part, on a listening objective. The listening objective may, for example, include a spatial component, a frequency component, or both.

According to some examples, the one or more types of audio processing changes may be based, at least in part, on one or more constraints. The one or more constraints may, for example, be based on a perceptual model, such as a model of human hearing. Alternatively, or additionally, the one or more constraints may involve audio content energy preservation, audio spatiality preservation, an audio energy vector, a regularization constraint, or a combination thereof.

In some examples, method 900 may involve updating an acoustic model of the audio environment, a model of echo management system performance, or both, after causing the one or more types of audio processing changes to be applied.

In some examples, determining the one or more types of audio processing changes may be based, at least in part, on an optimization of a cost function. According to some such examples, the cost function may correspond with, or be similar to, one of the cost functions of Equations 10-13. Other examples of audio processing changes that are based, at least in part, on optimizing a cost function are described in detail below.

### Examples of Audio Device Location Methods

As noted in the description of FIG. 9 and elsewhere herein, in some examples audio processing changes (such as those corresponding to a ducking solution) may be based, at least in part, on audio device location information. The locations of audio devices in an audio environment may be determined or estimated by various methods, including but not limited to those described in the following paragraphs.

Some such methods may involve receiving a direct indication by the user, e.g., using a smartphone or tablet apparatus to mark or indicate the approximate locations of the devices on a floorplan or similar diagrammatic representation of the environment. Such digital interfaces are already commonplace in managing the configuration, grouping, name, purpose and identity of smart home devices. For example, such a direct indication may be provided via the Amazon Alexa smartphone application, the Sonos S2 controller application, or a similar application.

Some examples may involve solving the basic trilateration problem using the measured signal strength (sometimes called the Received Signal Strength Indication or RSSI) of common wireless communication technologies such as Bluetooth, Wi-Fi, ZigBee, etc., to produce estimates of physical distance between the devices, e.g., as disclosed in J. Yang and Y. Chen, “Indoor Localization Using Improved RSS-Based Lateration Methods,” GLOBECOM 2009—2009 IEEE Global Telecommunications Conference, Honolulu, HI, 2009, pp. 1-6, doi: 10.1109/GLOCOM.2009.5425237 and/or as disclosed in Mardeni, R. & Othman, Shaifull & Nizam, (2010) “Node Positioning in ZigBee Network Using Trilateration Method Based on the Received Signal Strength Indicator (RSSI)” 46, both of which are hereby incorporated by reference.

In U.S. Pat. No. 10,779,084, entitled “Automatic Discovery and Localization of Speaker Locations in Surround Sound Systems,” which is hereby incorporated by reference, a system is described which can automatically locate the positions of loudspeakers and microphones in a listening environment by acoustically measuring the time-of-arrival (TOA) between each speaker and microphone.

International Publication No. WO 2021/127286 A1, entitled “Audio Device Auto-Location,” which is hereby incorporated by reference, discloses methods for estimating audio device locations, listener positions and listener locations in an audio environment. Some disclosed methods involve estimating audio device locations in an environment via direction of arrival (DOA) data and by determining interior angles for each of a plurality of triangles based on the DOA data. In some examples, each triangle has vertices that correspond with audio device locations. Some disclosed methods involve determining a side length for each side of each of the triangles and performing a forward alignment process of aligning each of the plurality of triangles to produce a forward alignment matrix. Some disclosed methods involve determining performing a reverse alignment process of aligning each of the plurality of triangles in a reverse sequence to produce a reverse alignment matrix. A final estimate of each audio device location may be based, at least in part, on values of the forward alignment matrix and values of the reverse alignment matrix.

Other disclosed methods of International Publication No. WO 2021/127286 A1 involve estimating a listener location and, in some instances, a listener location. Some such methods involve prompting the listener (e.g., via an audio prompt from one or more loudspeakers in the environment) to make one or more utterances and estimating the listener location according to DOA data. The DOA data may correspond to microphone data obtained by a plurality of microphones in the environment. The microphone data may correspond with detections of the one or more utterances by the microphones. At least some of the microphones may be co-located with loudspeakers. According to some examples, estimating a listener location may involve a triangulation process. Some such examples involve triangulating the user's voice by finding the point of intersection between DOA vectors passing through the audio devices. Some disclosed methods of determining a listener orientation involve prompting the user to identify a one or more loudspeaker locations. Some such examples involve prompting the user to identify one or more loudspeaker locations by moving next to the loudspeaker location(s) and making an utterance. Other examples involve prompting the user to identify one or more loudspeaker locations by pointing to each of the one or more loudspeaker locations with a handheld device, such as a cellular telephone that includes an inertial sensor system and a wireless interface configured for communicating with a control system that is controlling the audio devices of the audio environment (such as a control system of an orchestrating device). Some disclosed methods involve determining a listener orientation by causing loudspeakers to render an audio object such that the audio object seems to rotate around the listener, and prompting the listener to make an utterance (such as “Stop!”) when the listener perceives the audio object to be in a location, such as a loudspeaker location, a television location, etc. Some disclosed methods involve determining a location and/or orientation of a listener via camera data, e.g., by determining a relative location of the listener and one or more audio devices of the audio environment according to the camera data, by determining an orientation of the listener relative to one or more audio devices of the audio environment according to the camera data (e.g., according to the direction that the listener is facing), etc.

In Shi, Guangi et al, Spatial Calibration of Surround Sound Systems including Listener Position Estimation, (AES 137^{th} Convention, October 2014), which is hereby incorporated by reference, a system is described in which a single linear microphone array associated with a component of the reproduction system whose location is predictable, such as a soundbar a front center speaker, measures the time-difference-of-arrival (TDOA) for both satellite loudspeakers and a listener to locate the positions of both the loudspeakers and listener. In this case, the listening orientation is inherently defined as the line connecting the detected listening position and the component of the reproduction system that includes the linear microphone array, such as a sound bar that is co-located with a television (placed directly above or below the television). Because the sound bar's location is predictably placed directly above or below the video screen, the geometry of the measured distance and incident angle can be translated to an absolute position relative to any point in front of that reference sound bar location using simple trigonometric principles. The distance between a loudspeaker and a microphone of the linear microphone array can be estimated by playing a test signal and measuring the time of flight (TOF) between the emitting loudspeaker and the receiving microphone. The time delay of the direct component of a measured impulse response can be used for this purpose. The impulse response between the loudspeaker and a microphone array element can be obtained by playing a test signal through the loudspeaker under analysis. For example, either a maximum length sequence (MLS) or a chirp signal (also known as logarithmic sine sweep) can be used as the test signal. The room impulse response can be obtained by calculating the circular cross-correlation between the captured signal and the MLS input. FIG. 2 of this reference shows an echoic impulse response obtained using a MLS input. This impulse response is said to be similar to a measurement taken in a typical office or living room. The delay of the direct component is used to estimate the distance between the loudspeaker and the microphone array element. For loudspeaker distance estimation, any loopback latency of the audio device used to playback the test signal should be computed and removed from the measured TOF estimate.

### Examples of Estimating the Location and Orientation of a Person in an Audio Environment

The location and orientation of a person in an audio environment may be determined or estimated by various methods, including but not limited to those described in the following paragraphs.

In Hess, Wolfgang, Head-Tracking Techniques for Virtual Acoustic Applications, (AES 133rd Convention, October 2012), which is hereby incorporated by reference, numerous commercially available techniques for tracking both the position and orientation of a listener's head in the context of spatial audio reproduction systems are presented. One particular example discussed is the Microsoft Kinect. With its depth sensing and standard cameras along with a publicly available software (Windows Software Development Kit (SDK)), the positions and orientations of the heads of several listeners in a space can be simultaneously tracked using a combination of skeletal tracking and facial recognition. Although the Kinect for Windows has been discontinued, the Azure Kinect developer kit (DK), which implements the next generation of Microsoft's depth sensor, is currently available.

In U.S. Pat. No. 10,779,084, entitled “Automatic Discovery and Localization of Speaker Locations in Surround Sound Systems,” which is hereby incorporated by reference, a system is described which can automatically locate the positions of loudspeakers and microphones in a listening environment by acoustically measuring the time-of-arrival (TOA) between each speaker and microphone. A listening position may be detected by placing and locating a microphone at a desired listening position (a microphone in a mobile phone held by the listener, for example), and an associated listening orientation may be defined by placing another microphone at a point in the viewing direction of the listener, e.g. at the TV. Alternatively, the listening orientation may be defined by locating a loudspeaker in the viewing direction, e.g. the loudspeakers on the TV.

International Publication No. WO 2021/127286 A1, entitled “Audio Device Auto-Location,” which is hereby incorporated by reference, discloses methods for estimating audio device locations, listener positions and listener locations in an audio environment. Some disclosed methods involve estimating audio device locations in an environment via direction of arrival (DOA) data and by determining interior angles for each of a plurality of triangles based on the DOA data. In some examples, each triangle has vertices that correspond with audio device locations. Some disclosed methods involve determining a side length for each side of each of the triangles and performing a forward alignment process of aligning each of the plurality of triangles to produce a forward alignment matrix. Some disclosed methods involve determining performing a reverse alignment process of aligning each of the plurality of triangles in a reverse sequence to produce a reverse alignment matrix. A final estimate of each audio device location may be based, at least in part, on values of the forward alignment matrix and values of the reverse alignment matrix.

Other disclosed methods of International Publication No. WO 2021/127286 A1 involve estimating a listener location and, in some instances, a listener location. Some such methods involve prompting the listener (e.g., via an audio prompt from one or more loudspeakers in the environment) to make one or more utterances and estimating the listener location according to DOA data. The DOA data may correspond to microphone data obtained by a plurality of microphones in the environment. The microphone data may correspond with detections of the one or more utterances by the microphones. At least some of the microphones may be co-located with loudspeakers. According to some examples, estimating a listener location may involve a triangulation process. Some such examples involve triangulating the user's voice by finding the point of intersection between DOA vectors passing through the audio devices. Some disclosed methods of determining a listener orientation involve prompting the user to identify a one or more loudspeaker locations. Some such examples involve prompting the user to identify one or more loudspeaker locations by moving next to the loudspeaker location(s) and making an utterance. Other examples involve prompting the user to identify one or more loudspeaker locations by pointing to each of the one or more loudspeaker locations with a handheld device, such as a cellular telephone that includes an inertial sensor system and a wireless interface configured for communicating with a control system that is controlling the audio devices of the audio environment (such as a control system of an orchestrating device). Some disclosed methods involve determining a listener orientation by causing loudspeakers to render an audio object such that the audio object seems to rotate around the listener, and prompting the listener to make an utterance (such as “Stop!”) when the listener perceives the audio object to be in a location, such as a loudspeaker location, a television location, etc. Some disclosed methods involve determining a location and/or orientation of a listener via camera data, e.g., by determining a relative location of the listener and one or more audio devices of the audio environment according to the camera data, by determining an orientation of the listener relative to one or more audio devices of the audio environment according to the camera data (e.g., according to the direction that the listener is facing), etc.

In Shi, Guangi et al, Spatial Calibration of Surround Sound Systems including Listener Position Estimation, (AES 137th Convention, October 2014), which is hereby incorporated by reference, a system is described in which a single linear microphone array associated with a component of the reproduction system whose location is predictable, such as a soundbar a front center speaker, measures the time-difference-of-arrival (TDOA) for both satellite loudspeakers and a listener to locate the positions of both the loudspeakers and listener. In this case, the listening orientation is inherently defined as the line connecting the detected listening position and the component of the reproduction system that includes the linear microphone array, such as a sound bar that is co-located with a television (placed directly above or below the television). Because the sound bar's location is predictably placed directly above or below the video screen, the geometry of the measured distance and incident angle can be translated to an absolute position relative to any point in front of that reference sound bar location using simple trigonometric principles. The distance between a loudspeaker and a microphone of the linear microphone array can be estimated by playing a test signal and measuring the time of flight (TOF) between the emitting loudspeaker and the receiving microphone. The time delay of the direct component of a measured impulse response can be used for this purpose. The impulse response between the loudspeaker and a microphone array element can be obtained by playing a test signal through the loudspeaker under analysis. For example, either a maximum length sequence (MLS) or a chirp signal (also known as logarithmic sine sweep) can be used as the test signal. The room impulse response can be obtained by calculating the circular cross-correlation between the captured signal and the MLS input. FIG. 2 of this reference shows an echoic impulse response obtained using a MLS input. This impulse response is said to be similar to a measurement taken in a typical office or living room. The delay of the direct component is used to estimate the distance between the loudspeaker and the microphone array element. For loudspeaker distance estimation, any loopback latency of the audio device used to playback the test signal should be computed and removed from the measured TOF estimate.

### Estimating the Location of a Person According to User Zones

In some examples, the estimated location of a person in an audio environment may correspond with a user zone. This section describes methods for estimating a user zone in which a person is located based, at least in part, on microphone signals.

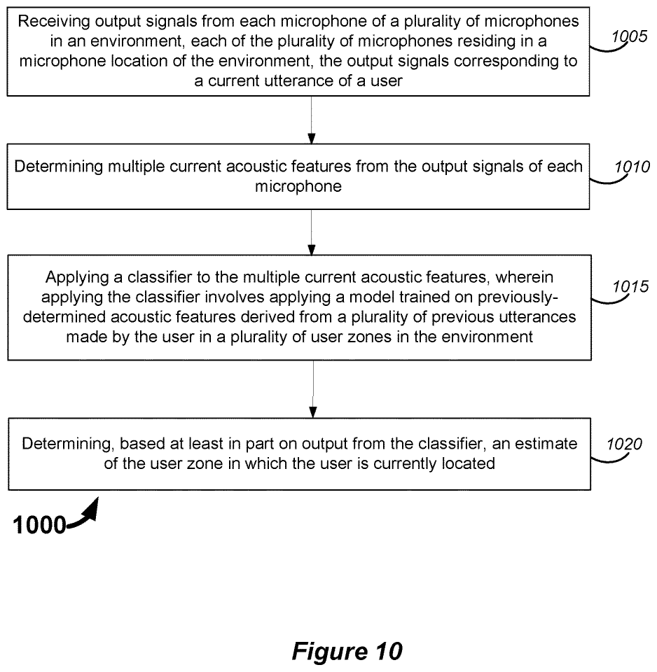

FIG. 10 is a flow diagram that outlines one example of a method that may be performed by an apparatus such as that shown in FIG. 1A. The blocks of method 1000, like other methods described herein, are not necessarily performed in the order indicated. Moreover, such methods may include more or fewer blocks than shown and/or described. In this implementation, method 1000 involves estimating a user's location in an environment.

In this example, block 1005 involves receiving output signals from each microphone of a plurality of microphones in the environment. In this instance, each of the plurality of microphones resides in a microphone location of the environment. According to this example, the output signals correspond to a current utterance of a user. In some examples, the current utterance may be, or may include, a wakeword utterance. Block 1005 may, for example, involve a control system (such as the control system 120 of FIG. 1A) receiving output signals from each microphone of a plurality of microphones in the environment via an interface system (such as the interface system 205 of FIG. 1A).

In some examples, at least some of the microphones in the environment may provide output signals that are asynchronous with respect to the output signals provided by one or more other microphones. For example, a first microphone of the plurality of microphones may sample audio data according to a first sample clock and a second microphone of the plurality of microphones may sample audio data according to a second sample clock. In some instances, at least one of the microphones in the environment may be included, in or configured for communication with, a smart audio device.

According to this example, block 1010 involves determining multiple current acoustic features from the output signals of each microphone. In this example, the “current acoustic features” are acoustic features derived from the “current utterance” of block 1005. In some implementations, block 1010 may involve receiving the multiple current acoustic features from one or more other devices. For example, block 1010 may involve receiving at least some of the multiple current acoustic features from one or more wakeword detectors implemented by one or more other devices. Alternatively, or additionally, in some implementations block 1010 may involve determining the multiple current acoustic features from the output signals.

Whether the acoustic features are determined by a single device or multiple devices, the acoustic features may be determined asynchronously. If the acoustic features are determined by multiple devices, the acoustic features would generally be determined asynchronously unless the devices were configured to coordinate the process of determining acoustic features. If the acoustic features are determined by a single device, in some implementations the acoustic features may nonetheless be determined asynchronously because the single device may receive the output signals of each microphone at different times. In some examples, the acoustic features may be determined asynchronously because at least some of the microphones in the environment may provide output signals that are asynchronous with respect to the output signals provided by one or more other microphones.

In some examples, the acoustic features may include a wakeword confidence metric, a wakeword duration metric and/or at least one received level metric. The received level metric may indicate a received level of a sound detected by a microphone and may correspond to a level of a microphone's output signal.

Alternatively, or additionally, the acoustic features may include one or more of the following:
Mean state entropy (purity) for each wakeword state along the 1-best (Viterbi) alignment with the acoustic model.
CTC-loss (Connectionist Temporal Classification Loss) against the acoustic models of the wakeword detectors.
A wakeword detector may be trained to provide an estimate of distance of the talker from the microphone and/or an RT60 estimate in addition to the wakeword confidence. The distance estimate and/or the RT60 estimate may be acoustic features.
Instead of, or in addition to, broadband received level/power at a microphone, an acoustic feature may be the received level in a number of log/Mel/Bark-spaced frequency bands. The frequency bands may vary according to the particular implementation (e.g., 2 frequency bands, 5 frequency bands, 20 frequency bands, 50 frequency bands, 1 octave frequency bands or ⅓ octave frequency bands).
Cepstral representation of the spectral information in the preceding point, computed by taking the DCT (discrete cosine transform) of the logarithm of the band powers.
Band powers in frequency bands weighted for human speech. For example, acoustic features may be based upon only a particular frequency band (for example, 400 Hz-1.5 kHz). Higher and lower frequencies may, in this example, be disregarded.
Per-band or per-bin voice activity detector confidence.
Acoustic features may be based, at least in part, on a long-term noise estimate so as to ignore microphones that have a poor signal-to-noise ratio.
Kurtosis as a measure of speech “peakiness.” Kurtosis can be an indicator of smearing by a long reverberation tail.
Estimated wakeword onset times. One would expect onset and duration to be equal within a frame or so across all microphones. An outlier can give a clue of an unreliable estimate. This assumes some level of synchrony—not necessarily to the sample—but, e.g., to the frame of a few tens of milliseconds.

According to this example, block 1015 involves applying a classifier to the multiple current acoustic features. In some such examples, applying the classifier may involve applying a model trained on previously-determined acoustic features derived from a plurality of previous utterances made by the user in a plurality of user zones in the environment. Various examples are provided herein.

In some examples, the user zones may include a sink area, a food preparation area, a refrigerator area, a dining area, a couch area, a television area, a bedroom area and/or a doorway area. According to some examples, one or more of the user zones may be a predetermined user zone. In some such examples, one or more predetermined user zones may have been selectable by a user during a training process.

In some implementations, applying the classifier may involve applying a Gaussian Mixture Model trained on the previous utterances. According to some such implementations, applying the classifier may involve applying a Gaussian Mixture Model trained on one or more of normalized wakeword confidence, normalized mean received level, or maximum received level of the previous utterances. However, in alternative implementations applying the classifier may be based on a different model, such as one of the other models disclosed herein. In some instances, the model may be trained using training data that is labelled with user zones. However, in some examples applying the classifier involves applying a model trained using unlabelled training data that is not labelled with user zones.

In some examples, the previous utterances may have been, or may have included, wakeword utterances. According to some such examples, the previous utterances and the current utterance may have been utterances of the same wakeword.

In this example, block 1020 involves determining, based at least in part on output from the classifier, an estimate of the user zone in which the user is currently located. In some such examples, the estimate may be determined without reference to geometric locations of the plurality of microphones. For example, the estimate may be determined without reference to the coordinates of individual microphones. In some examples, the estimate may be determined without estimating a geometric location of the user.

Some implementations of the method 1000 may involve selecting at least one speaker according to the estimated user zone. Some such implementations may involve controlling at least one selected speaker to provide sound to the estimated user zone. Alternatively, or additionally, some implementations of the method 1000 may involve selecting at least one microphone according to the estimated user zone. Some such implementations may involve providing signals output by at least one selected microphone to a smart audio device.

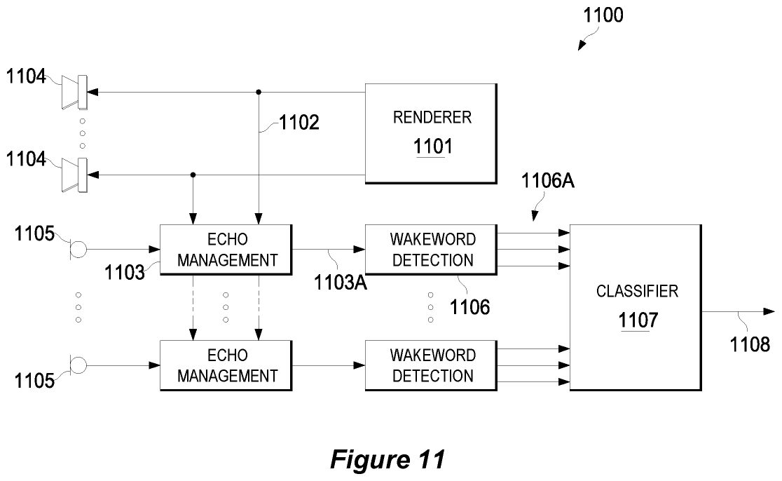

FIG. 11 is a block diagram of elements of one example of an embodiment that is configured to implement a zone classifier. According to this example, system 1100 includes a plurality of loudspeakers 1104 distributed in at least a portion of an environment (e.g., an environment such as that illustrated in FIG. 1A or FIG. 1B). In this example, the system 1100 includes a multichannel loudspeaker renderer 1101. According to this implementation, the outputs of the multichannel loudspeaker renderer 1101 serve as both loudspeaker driving signals (speaker feeds for driving speakers 1104) and echo references. In this implementation, the echo references are provided to echo management subsystems 1103 via a plurality of loudspeaker reference channels 1102, which include at least some of the speaker feed signals output from renderer 1101.

In this implementation, the system 1100 includes a plurality of echo management subsystems 1103. According to this example, the echo management subsystems 1103 are configured to implement one or more echo suppression processes and/or one or more echo cancellation processes. In this example, each of the echo management subsystems 1103 provides a corresponding echo management output 1103A to one of the wakeword detectors 1106. The echo management output 1103A has attenuated echo relative to the input to the relevant one of the echo management subsystems 1103.

According to this implementation, the system 1100 includes N microphones 1105 (N being an integer) distributed in at least a portion of the environment (e.g., the environment illustrated in FIG. 1A or FIG. 1B). The microphones may include array microphones and/or spot microphones. For example, one or more smart audio devices located in the environment may include an array of microphones. In this example, the outputs of microphones 1105 are provided as input to the echo management subsystems 1103. According to this implementation, each of echo management subsystems 1103 captures the output of an individual microphone 1105 or an individual group or subset of the microphones 1105).

In this example, the system 1100 includes a plurality of wakeword detectors 1106. According to this example, each of the wakeword detectors 1106 receives the audio output from one of the echo management subsystems 1103 and outputs a plurality of acoustic features 1106A. The acoustic features 1106A output from each echo management subsystem 1103 may include (but are not limited to): wakeword confidence, wakeword duration and measures of received level. Although three arrows, depicting three acoustic features 1106A, are shown as being output from each echo management subsystem 1103, more or fewer acoustic features 1106A may be output in alternative implementations. Moreover, although these three arrows are impinging on the classifier 1107 along a more or less vertical line, this does not indicate that the classifier 1107 necessarily receives the acoustic features 1106A from all of the wakeword detectors 1106 at the same time. As noted elsewhere herein, the acoustic features 1106A may, in some instances, be determined and/or provided to the classifier asynchronously.

According to this implementation, the system 1100 includes a zone classifier 1107, which may also be referred to as a classifier 1107. In this example, the classifier receives the plurality of features 1106A from the plurality of wakeword detectors 1106 for a plurality of (e.g., all of) the microphones 1105 in the environment. According to this example, the output 1108 of the zone classifier 1107 corresponds to an an estimate of the user zone in which the user is currently located. According to some such examples, the output 1108 may correspond to one or more posterior probabilities. An estimate of the user zone in which the user is currently located may be, or may correspond to, a maximum a posteriori probability according to Bayesian statistics.

We next describe example implementations of a classifier, which may in some examples correspond with the zone classifier 1107 of FIG. 11. Let xᵢ(n) be the ith microphone signal, i={1 . . . N}, at discrete time n (i.e., the microphone signals xᵢ(n) are the outputs of the N microphones 1105). Processing of the N signals xᵢ(n) in echo management subsystems 1103 generates ‘clean’ microphone signals eᵢ(n), where i={1 . . . N}, each at a discrete time n. Clean signals eᵢ(n), referred to as 1103A in FIG. 11, are fed to wakeword detectors 1106 in this example. Here, each wakeword detector 1106 produces a vector of features wᵢ(j), referred to as 1106A in FIG. 11, where j={1 . . . J} is an index corresponding to the jth wakeword utterance. In this example, the classifier 1107 takes as input an aggregate feature set

$$W ( j ) = {[ {w}_{1}^{T} ( j ) … {w}_{N}^{T} ( j ) ]}^{T} .$$

According to some implementations, a set of zone labels Cₖ, for k={1 . . . K}, may correspond to a number, K, of different user zones in an environment. For example, the user zones may include a couch zone, a kitchen zone, a reading chair zone, etc. Some examples may define more than one zone within a kitchen or other room. For example, a kitchen area may include a sink zone, a food preparation zone, a refrigerator zone and a dining zone. Similarly, a living room area may include a couch zone, a television zone, a reading chair zone, one or more doorway zones, etc. The zone labels for these zones may be selectable by a user, e.g., during a training phase.

In some implementations, classifier 1107 estimates posterior probabilities p(Cₖ|W(j)) of the feature set W(j), for example by using a Bayesian classifier. Probabilities p(Cₖ|W(j)) indicate a probability (for the j^{th} utterance and the k^{th} zone, for each of the zones Cₖ, and each of the utterances) that the user is in each of the zones Cₖ, and are an example of output 1108 of classifier 1107.

According to some examples, training data may be gathered (e.g., for each user zone) by prompting a user to select or define a zone, e.g., a couch zone. The training process may involve prompting the user make a training utterance, such as a wakeword, in the vicinity of a selected or defined zone. In a couch zone example, the training process may involve prompting the user to make the training utterance at the center and extreme edges of a couch. The training process may involve prompting the user to repeat the training utterance several times at each location within the user zone. The user may then be prompted to move to another user zone and to continue until all designated user zones have been covered.

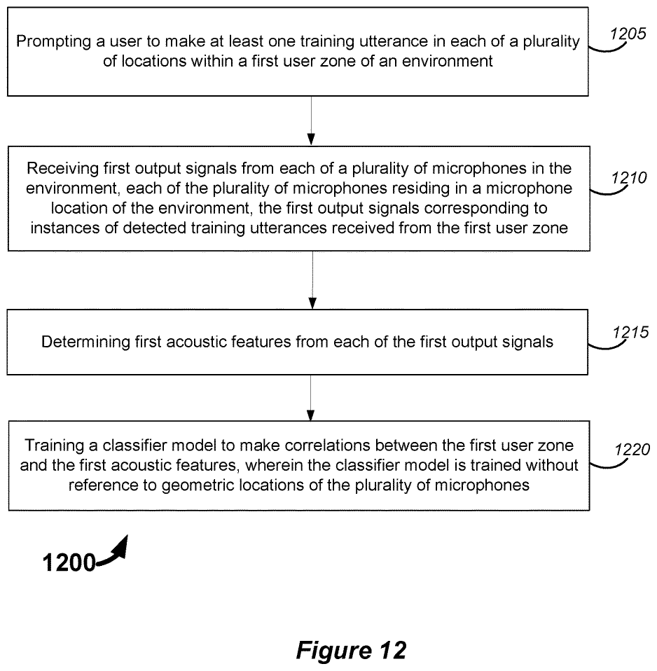

FIG. 12 is a flow diagram that outlines one example of a method that may be performed by an apparatus such as apparatus 200 of FIG. 1A. The blocks of method 1200, like other methods described herein, are not necessarily performed in the order indicated. Moreover, such methods may include more or fewer blocks than shown and/or described. In this implementation, method 1200 involves training a classifier for estimating a user's location in an environment.

In this example, block 1205 involves prompting a user to make at least one training utterance in each of a plurality of locations within a first user zone of an environment. The training utterance(s) may, in some examples, be one or more instances of a wakeword utterance. According to some implementations, the first user zone may be any user zone selected and/or defined by a user. In some instances, a control system may create a corresponding zone label (e.g., a corresponding instance of one of the zone labels Cₖ described above) and may associate the zone label with training data obtained for the first user zone.

An automated prompting system may be used to collect these training data. As noted above, the interface system 205 of apparatus 200 may include one or more devices for implementing a user interface, such as one or more microphones, one or more speakers, a display system, a touch sensor system and/or a gesture sensor system. For example, the apparatus 200 may provide the user with the following prompts on a screen of the display system or hear them announced via one or more speakers during the training process:
“Move to the couch.”
“Say the wakeword ten times while moving your head about.”
“Move to a position halfway between the couch and the reading chair and say the wakeword ten times.”
“Stand in the kitchen as if cooking and say the wakeword ten times.”

In this example, block 1210 involves receiving first output signals from each of a plurality of microphones in the environment. In some examples, block 1210 may involve receiving the first output signals from all of the active microphones in the environment, whereas in other examples block 1210 may involve receiving the first output signals from a subset of all of the active microphones in the environment. In some examples, at least some of the microphones in the environment may provide output signals that are asynchronous with respect to the output signals provided by one or more other microphones. For example, a first microphone of the plurality of microphones may sample audio data according to a first sample clock and a second microphone of the plurality of microphones may sample audio data according to a second sample clock.

In this example, each microphone of the plurality of microphones resides in a microphone location of the environment. In this example, the first output signals correspond to instances of detected training utterances received from the first user zone. Because block 1205 involves prompting the user to make at least one training utterance in each of a plurality of locations within the first user zone of an environment, in this example the term “first output signals” refers to a set of all output signals corresponding to training utterances for the first user zone. In other examples the term “first output signals” may refer to a subset of all output signals corresponding to training utterances for the first user zone.

According to this example, block 1215 involves determining one or more first acoustic features from each of the first output signals. In some examples, the first acoustic features may include a wakeword confidence metric and/or a received level metric. For example, the first acoustic features may include a normalized wakeword confidence metric, an indication of normalized mean received level and/or an indication of maximum received level.

As noted above, because block 1205 involves prompting the user to make at least one training utterance in each of a plurality of locations within the first user zone of an environment, in this example the term “first output signals” refers to a set of all output signals corresponding to training utterances for the first user zone. Accordingly, in this example the term “first acoustic features” refers to a set of acoustic features derived from the set of all output signals corresponding to training utterances for the first user zone. Therefore, in this example the set of first acoustic features is at least as large as the set of first output signals. If, for example, two acoustic features were determined from each of the output signals, the set of first acoustic features would be twice as large as the set of first output signals.

In this example, block 1220 involves training a classifier model to make correlations between the first user zone and the first acoustic features. The classifier model may, for example, be any of those disclosed herein. According to this implementation, the classifier model is trained without reference to geometric locations of the plurality of microphones. In other words, in this example, data regarding geometric locations of the plurality of microphones (e.g., microphone coordinate data) is not provided to the classifier model during the training process.

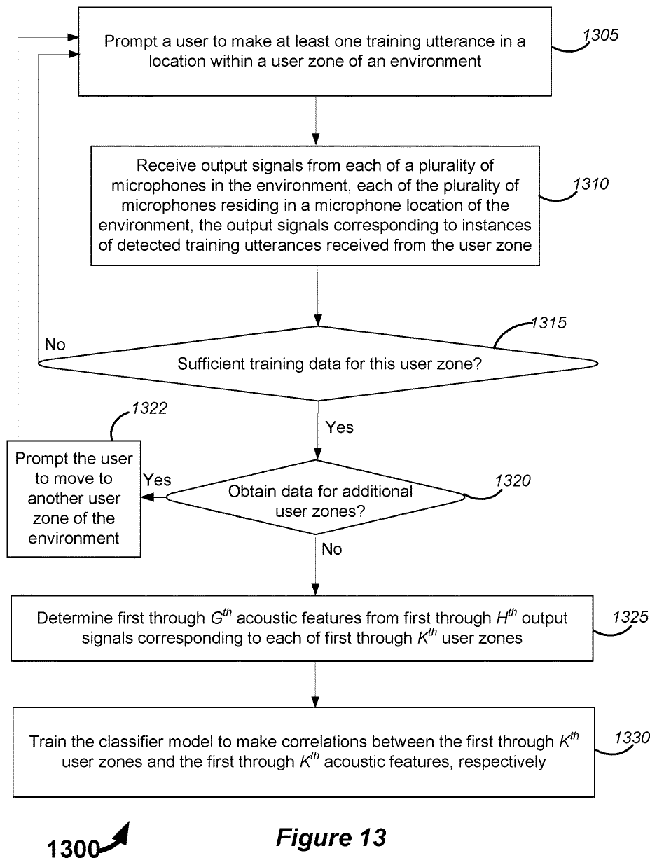

FIG. 13 is a flow diagram that outlines another example of a method that may be performed by an apparatus such as apparatus 200 of FIG. 1A. The blocks of method 1300, like other methods described herein, are not necessarily performed in the order indicated. For example, in some implementations at least a portion of the acoustic feature determination process of block 1325 may be performed prior to block 1315 or block 1320. Moreover, such methods may include more or fewer blocks than shown and/or described. In this implementation, method 1300 involves training a classifier for estimating a user's location in an environment. Method 1300 provides an example of extending method 1200 to multiple user zones of the environment.

In this example, block 1305 involves prompting a user to make at least one training utterance in a location within a user zone of an environment. In some instances, block 1305 may be performed in the manner described above with reference to block 1205 of FIG. 12, except that block 1305 pertains to a single location within a user zone. The training utterance(s) may, in some examples, be one or more instances of a wakeword utterance. According to some implementations, the user zone may be any user zone selected and/or defined by a user. In some instances, a control system may create a corresponding zone label (e.g., a corresponding instance of one of the zone labels Cₖ described above) and may associate the zone label with training data obtained for the user zone.

According to this example, block 1310 is performed substantially as described above with reference to block 1210 of FIG. 12. However, in this example the process of block 1310 is generalized to any user zone, not necessarily the first user zone for which training data are acquired. Accordingly, the output signals received in block 1310 are “output signals from each of a plurality of microphones in the environment, each of the plurality of microphones residing in a microphone location of the environment, the output signals corresponding to instances of detected training utterances received from the user zone.” In this example, the term “output signals” refers to a set of all output signals corresponding to one or more training utterances in a location of the user zone. In other examples the term “output signals” may refer to a subset of all output signals corresponding to one or more training utterances in a location of the user zone.

According to this example, block 1315 involves determining whether sufficient training data have been acquired for the current user zone. In some such examples, block 1315 may involve determining whether output signals corresponding to a threshold number of training utterances have been obtained for the current user zone. Alternatively, or additionally, block 1315 may involve determining whether output signals corresponding to training utterances in a threshold number of locations within the current user zone have been obtained. If not, method 1300 reverts to block 1305 in this example and the user is prompted to make at least one additional utterance at a location within the same user zone.

However, if it is determined in block 1315 that sufficient training data have been acquired for the current user zone, in this example the process continues to block 1320. According to this example, block 1320 involves determining whether to obtain training data for additional user zones. According to some examples, block 1320 may involve determining whether training data have been obtained for each user zone that a user has previously identified. In other examples, block 1320 may involve determining whether training data have been obtained for a minimum number of user zones. The minimum number may have been selected by a user. In other examples, the minimum number may be a recommended minimum number per environment, a recommended minimum number per room of the environment, etc.

If it is determined in block 1320 that training data should be obtained for additional user zones, in this example the process continues to block 1322, which involves prompting the user to move to another user zone of the environment. In some examples, the next user zone may be selectable by the user. According to this example, the process continues to block 1305 after the prompt of block 1322. In some such examples, the user may be prompted to confirm that the user has reached the new user zone after the prompt of block 1322. According to some such examples, the user may be required to confirm that the user has reached the new user zone before the prompt of block 1305 is provided.

If it is determined in block 1320 that training data should not be obtained for additional user zones, in this example the process continues to block 1325. In this example, method 1300 involves obtaining training data for K user zones. In this implementation, block 1325 involves determining first through G^{th} acoustic features from first through H^{th} output signals corresponding to each of the first through K^{th} user zones for which training data has been obtained. In this example, the term “first output signals” refers to a set of all output signals corresponding to training utterances for a first user zone and the term “H^{th} output signals” refers to a set of all output signals corresponding to training utterances for a K^{th} user zone. Similarly, the term “first acoustic features” refers to a set of acoustic features determined from the first output signals and the term “G^{th} acoustic features” refers to a set of acoustic features determined from the H^{th} output signals.

According to these examples, block 1330 involves training a classifier model to make correlations between the first through K^{th} user zones and the first through K^{th} acoustic features, respectively. The classifier model may, for example, be any of the classifier models disclosed herein.

In the foregoing example, the user zones are labeled (e.g., according to a corresponding instance of one of the zone labels Cₖ described above). However, the model may either be trained according to labeled or unlabeled user zones, depending on the particular implementation. In the labeled case, each training utterance may be paired with a label corresponding to a user zone, e.g., as follows:

$$p ( {C}_{k} \vert W ( j ) ) = \{ \begin{matrix}1 & k = {k}^{′} \\ 0 & otherwise\end{matrix} \} ,$$

Training the classifier model may involve determining a best fit for the labeled training data. Without loss of generality, appropriate classification approaches for a classifier model may include:
A Bayes' Classifier, for example with per-class distributions described by multivariate normal distributions, full-covariance Gaussian Mixture Models or diagonal-covariance Gaussian Mixture Models;
Vector Quantization;
Nearest Neighbor (k-means);
A Neural Network having a SoftMax output layer with one output corresponding to each class;
A Support Vector Machine (SVM); and/or
Boosting techniques, such as Gradient Boosting Machines (GBMs)

In one example of implementing the unlabeled case, data may be automatically split into K clusters, where K may also be unknown. The unlabeled automatic splitting can be performed, for example, by using a classical clustering technique, e.g., the k-means algorithm or Gaussian Mixture Modelling.

In order to improve robustness, regularization may be applied to the classifier model training and model parameters may be updated over time as new utterances are made.

We next describe further aspects of an embodiment.

An example acoustic feature set (e.g., acoustic features 1106A of FIG. 11) may include the likelihood of wakeword confidence, mean received level over the estimated duration of the most confident wakeword, and maximum received level over the duration of the most confident wakeword. Features may be normalized relative to their maximum values for each wakeword utterance. Training data may be labeled and a full covariance Gaussian Mixture Model (GMM) may be trained to maximize expectation of the training labels. The estimated zone may be the class that maximizes posterior probability.

The above description of some embodiments discusses learning an acoustic zone model from a set of training data collected during a prompted collection process. In that model, training time (or configuration mode) and run time (or regular mode) can be considered two distinct modes that the microphone system may be placed in. An extension to this scheme is online learning, in which some or all of the acoustic zone model is learnt or adapted online (e.g., at run time or in regular mode). In other words, even after the classifier is being applied in a “run time” process to make an estimate of a user zone in which the user is currently located (e.g., pursuant to method 1000 of FIG. 10, in some implementations the process of training the classifier may continue.

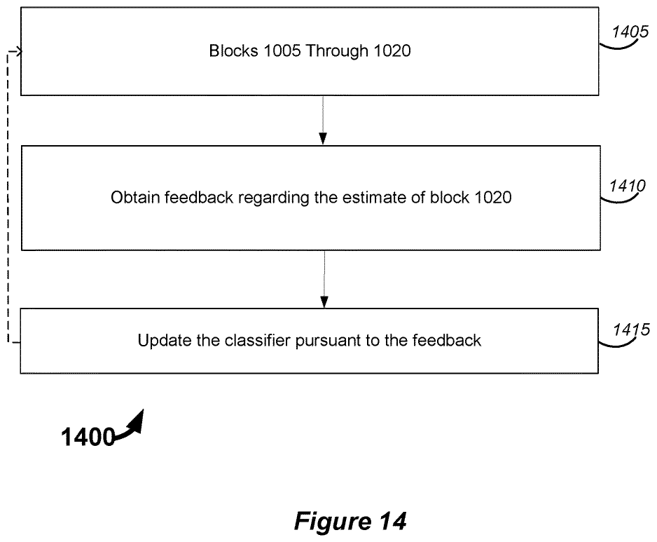

FIG. 14 is a flow diagram that outlines another example of a method that may be performed by an apparatus such as apparatus 200 of FIG. 1A. The blocks of method 1400, like other methods described herein, are not necessarily performed in the order indicated. Moreover, such methods may include more or fewer blocks than shown and/or described. In this implementation, method 1400 involves ongoing training of a classifier during a “run time” process of estimating a user's location in an environment. Method 1400 is an example of what is referred to herein as an online learning mode.

In this example, block 1405 of method 1400 corresponds to blocks 1005-1020 of method 1000. Here, block 1405 involves providing in an estimate, based at least in part on output from the classifier, of a user zone in which the user is currently located. According to this implementation, block 1410 involves obtaining implicit or explicit feedback regarding the estimate of block 1405. In block 1415, the classifier is updated pursuant to the feedback received in block 1405. Block 1415 may, for example, involve one or more reinforcement learning methods. As suggested by the dashed arrow from block 1415 to block 1405, in some implementations method 1400 may involve reverting to block 1405. For example, method 1400 may involve providing future estimates of a user zone in which the user is located at that future time, based on applying the updated model.

Explicit techniques for obtaining feedback may include:
Asking the user whether the prediction was correct using a voice user interface (UI). For example, a sound indicative of the following may be provided to the user: “I think you are on the couch, please say ‘right’ or ‘wrong’”).
Informing the user that incorrect predictions may be corrected at any time using the voice UI. (e.g., sound indicative of the following may be provided to the user: “I am now able to predict where you are when you speak to me. If I predict wrongly, just say something like ‘Amanda, I'm not on the couch. I'm in the reading chair’”).
Informing the user that correct predictions may be rewarded at any time using the voice UI. (e.g., sound indicative of the following may be provided to the user: “I am now able to predict where you are when you speak to me. If I predict correctly you can help to further improve my predictions by saying something like ‘Amanda, that's right. I am on the couch.’”).
Including physical buttons or other UI elements that a user can operate in order to give feedback (e.g., a thumbs up and/or thumbs down button on a physical device or in a smartphone app).

The goal of predicting the user zone in which the user is located may be to inform a microphone selection or adaptive beamforming scheme that attempts to pick up sound from the acoustic zone of the user more effectively, for example, in order to better recognize a command that follows the wakeword. In such scenarios, implicit techniques for obtaining feedback on the quality of zone prediction may include:
Penalizing predictions that result in misrecognition of the command following the wakeword. A proxy that may indicate misrecognition may include the user cutting short the voice assistant's response to a command, for example, by utterance a counter-command like, for example, “Amanda, stop!”;
Penalizing predictions that result in low confidence that a speech recognizer has successfully recognized a command. Many automatic speech recognition systems have the capability to return a confidence level with their result that can be used for this purpose;
Penalizing predictions that result in failure of a second-pass wakeword detector to retrospectively detect the wakeword with high confidence; and/or
Reinforcing predictions that result in highly confident recognition of the wakeword and/or correct recognition of the user's command.

Following is an example of a failure of a second-pass wakeword detector to retrospectively detect the wakeword with high confidence. Suppose that after obtaining output signals corresponding to a current utterance from microphones in an environment and after determining acoustic features based on the output signals (e.g., via a plurality of first pass wakeword detectors configured for communication with the microphones), the acoustic features are provided to a classifier. In other words, the acoustic features are presumed to correspond to a detected wakeword utterance. Suppose further that the classifier determines that the person who made the current utterance is most likely to be in zone 3, which corresponds to a reading chair in this example. There may, for example, be a particular microphone or learned combination of microphones that is known to be best for listening to the person's voice when the person is in zone 3, e.g., to send to a cloud-based virtual assistant service for voice command recognition.

Suppose further that after determining which microphone(s) will be used for speech recognition, but before the person's speech is actually sent to the virtual assistant service, a second-pass wakeword detector operates on microphone signals corresponding to speech detected by the chosen microphone(s) for zone 3 that you are about to submit for command recognition. If that second pass wakeword detector disagrees with your plurality of first pass wakeword detectors that the wakeword was actually uttered it is probably because the classifier incorrectly predicted the zone. Therefore, the classifier should be penalized.

Techniques for the a posteriori updating of the zone mapping model after one or more wakewords have been spoken may include:
Maximum a posteriori (MAP) adaptation of a Gaussian Mixture Model (GMM) or nearest neighbor model; and/or
Reinforcement learning, for example of a neural network, for example by associating an appropriate “one-hot” (in the case of correct prediction) or “one-cold” (in the case of incorrect prediction) ground truth label with the SoftMax output and applying online back propagation to determine new network weights.

Some examples of a MAP adaptation in this context may involve adjusting the means in the GMM each time a wakeword is spoken. In this manner, the means may become more like the acoustic features that are observed when subsequent wakewords are spoken. Alternatively, or additionally, such examples may involve adjusting the variance/covariance or mixture weight information in the GMM each time a wakeword is spoken.

For example, a MAP adaptation scheme may be as follows:

$${μ}_{i , new} = {μ}_{i , old} * α + x * ( 1 - α )$$

In the foregoing equation, μ_{i,old} represents the mean of the i^{th} Gaussian in the mixture, α represents a parameter which controls how aggressively MAP adaptation should occur (α may be in the range [0.9,0.999]) and x represents the feature vector of the new wakeword utterance. The index “i” would correspond to the mixture element that returns the highest a priori probability of containing the speaker's location at wakeword time.

Alternatively, each of the mixture elements may be adjusted according to their a priori probability of containing the wakeword, e.g., as follows:

$${M}_{i , new} = {μ}_{i , old} * {β}_{i} * \times ( 1 - {β}_{i} )$$

In the foregoing equation, βᵢ=α*(1−P(i)), wherein P(i) represents the a priori probability that the observation x is due to mixture element i.

In one reinforcement learning example, there may be three user zones. Suppose that for a particular wakeword, the model predicts the probabilities as being [0.2, 0.1, 0.7] for the three user zones. If a second source of information (for example, a second-pass wakeword detector) confirms that the third zone was correct, then the ground truth label could be [0, 0, 1] (“one hot”). The a posteriori updating of the zone mapping model may involve back-propagating the error through a neural network, effectively meaning that the neural network will more strongly predict zone 3 if shown the same input again. Conversely, if the second source of information shows that zone 3 was an incorrect prediction, the ground truth label could be [0.5, 0.5, 0.0] in one example. Back-propagating the error through the neural network would make the model less likely to predict zone 3 if shown the same input in the future.

Further Examples of Audio Processing Changes that Involve Optimization of a Cost Function

As noted elsewhere herein, in various disclosed examples one or more types of audio processing changes may be based on the optimization of a cost function. Some such examples involve flexible rendering.

Flexible rendering allows spatial audio to be rendered over an arbitrary number of arbitrarily placed speakers. In view of the widespread deployment of audio devices, including but not limited to smart audio devices (e.g., smart speakers) in the home, there is a need for realizing flexible rendering technology that allows consumer products to perform flexible rendering of audio, and playback of the so-rendered audio.

Several technologies have been developed to implement flexible rendering. They cast the rendering problem as one of cost function minimization, where the cost function consists of two terms: a first term that models the desired spatial impression that the renderer is trying to achieve, and a second term that assigns a cost to activating speakers. To date this second term has focused on creating a sparse solution where only speakers in close proximity to the desired spatial position of the audio being rendered are activated.

Playback of spatial audio in a consumer environment has typically been tied to a prescribed number of loudspeakers placed in prescribed positions: for example, 5.1 and 7.1 surround sound. In these cases, content is authored specifically for the associated loudspeakers and encoded as discrete channels, one for each loudspeaker (e.g., Dolby Digital, or Dolby Digital Plus, etc.) More recently, immersive, object-based spatial audio formats have been introduced (Dolby Atmos) which break this association between the content and specific loudspeaker locations. Instead, the content may be described as a collection of individual audio objects, each with possibly time varying metadata describing the desired perceived location of said audio objects in three-dimensional space. At playback time, the content is transformed into loudspeaker feeds by a renderer which adapts to the number and location of loudspeakers in the playback system. Many such renderers, however, still constrain the locations of the set of loudspeakers to be one of a set of prescribed layouts (for example 3.1.2, 5.1.2, 7.1.4, 9.1.6, etc. with Dolby Atmos).

Moving beyond such constrained rendering, methods have been developed which allow object-based audio to be rendered flexibly over a truly arbitrary number of loudspeakers placed at arbitrary positions. These methods require that the renderer have knowledge of the number and physical locations of the loudspeakers in the listening space. For such a system to be practical for the average consumer, an automated method for locating the loudspeakers would be desirable. One such method relies on the use of a multitude of microphones, possibly co-located with the loudspeakers. By playing audio signals through the loudspeakers and recording with the microphones, the distance between each loudspeaker and microphone is estimated. From these distances the locations of both the loudspeakers and microphones are subsequently deduced.

Simultaneous to the introduction of object-based spatial audio in the consumer space has been the rapid adoption of so-called “smart speakers”, such as the Amazon Echo line of products. The tremendous popularity of these devices can be attributed to their simplicity and convenience afforded by wireless connectivity and an integrated voice interface (Amazon's Alexa, for example), but the sonic capabilities of these devices has generally been limited, particularly with respect to spatial audio. In most cases these devices are constrained to mono or stereo playback. However, combining the aforementioned flexible rendering and auto-location technologies with a plurality of orchestrated smart speakers may yield a system with very sophisticated spatial playback capabilities and that still remains extremely simple for the consumer to set up. A consumer can place as many or few of the speakers as desired, wherever is convenient, without the need to run speaker wires due to the wireless connectivity, and the built-in microphones can be used to automatically locate the speakers for the associated flexible renderer.

Conventional flexible rendering algorithms are designed to achieve a particular desired perceived spatial impression as closely as possible. In a system of orchestrated smart speakers, at times, maintenance of this spatial impression may not be the most important or desired objective. For example, if someone is simultaneously attempting to speak to an integrated voice assistant, it may be desirable to momentarily alter the spatial rendering in a manner that reduces the relative playback levels on speakers near certain microphones in order to increase the signal to noise ratio and/or the signal to echo ratio (SER) of microphone signals that include the detected speech. Some embodiments described herein may be implemented as modifications to existing flexible rendering methods, to allow such dynamic modification to spatial rendering, e.g., for the purpose of achieving one or more additional objectives.

Existing flexible rendering techniques include Center of Mass Amplitude Panning (CMAP) and Flexible Virtualization (FV). From a high level, both these techniques render a set of one or more audio signals, each with an associated desired perceived spatial position, for playback over a set of two or more speakers, where the relative activation of speakers of the set is a function of a model of perceived spatial position of said audio signals played back over the speakers and a proximity of the desired perceived spatial position of the audio signals to the positions of the speakers. The model ensures that the audio signal is heard by the listener near its intended spatial position, and the proximity term controls which speakers are used to achieve this spatial impression. In particular, the proximity term favors the activation of speakers that are near the desired perceived spatial position of the audio signal. For both CMAP and FV, this functional relationship is conveniently derived from a cost function written as the sum of two terms, one for the spatial aspect and one for proximity:

$$C ( g ) = {C}_{spatial} ( g , \vec{o} , \{ {\vec{s}}_{i} \} ) + {C}_{proximity} ( g , \vec{o} , \{ {\vec{s}}_{i} \} ) \qquad ( 17 )$$

Here, the set {\vec{s}ᵢ} denotes the positions of a set of M loudspeakers, \vec{o} denotes the desired perceived spatial position of the audio signal, and g denotes an M dimensional vector of speaker activations. For CMAP, each activation in the vector represents a gain per speaker, while for FV each activation represents a filter (in this second case g can equivalently be considered a vector of complex values at a particular frequency and a different g is computed across a plurality of frequencies to form the filter). The optimal vector of activations is found by minimizing the cost function across activations:

$${g}_{opt} = {min}_{g} C ( g , \vec{o} , \{ {\vec{s}}_{i} \} ) \qquad ( 18 a )$$

With certain definitions of the cost function, it is difficult to control the absolute level of the optimal activations resulting from the above minimization, though the relative level between the components of gₒₚₜ is appropriate. To deal with this problem, a subsequent normalization of gₒₚₜ may be performed so that the absolute level of the activations is controlled. For example, normalization of the vector to have unit length may be desirable, which is in line with a commonly used constant power panning rules:

$${\overline{g}}_{opt} = \frac{{g}_{opt}}{‖ {g}_{opt} ‖} \qquad ( 18 b )$$

The exact behavior of the flexible rendering algorithm is dictated by the particular construction of the two terms of the cost function, Cₛₚₐₜᵢₐₗ and C_{proximity}. For CMAP, Cₛₚₐₜᵢₐₗ is derived from a model that places the perceived spatial position of an audio signal playing from a set of loudspeakers at the center of mass of those loudspeakers' positions weighted by their associated activating gains gᵢ (elements of the vector g):

$$\vec{o} = \frac{{\sum }_{i = 1}^{M} {g}_{i} {\vec{s}}_{i}}{{\sum }_{i = 1}^{M} {g}_{i}} \qquad ( 19 )$$

Equation 19 is then manipulated into a spatial cost representing the squared error between the desired audio position and that produced by the activated loudspeakers:

$${C}_{spatial} ( g , \vec{o} , \{ {\vec{s}}_{i} \} ) = {‖ ( {\sum }_{i = 1}^{M} {g}_{i} ) \vec{o} - {\sum }_{i = 1}^{M} {g}_{i} {\vec{s}}_{i} ‖}^{2} = {‖ {\sum }_{i = 1}^{M} {g}_{i} ( \vec{o} - {\vec{s}}_{i} ) ‖}^{2} \qquad ( 20 )$$

With FV, the spatial term of the cost function is defined differently. There the goal is to produce a binaural response b corresponding to the audio object position \vec{o} at the left and right ears of the listener. Conceptually, b is a 2×1 vector of filters (one filter for each ear) but is more conveniently treated as a 2×1 vector of complex values at a particular frequency. Proceeding with this representation at a particular frequency, the desired binaural response may be retrieved from a set of HRTFs indexed by object position:

$$b = HRTF \{ \vec{o} \} \qquad ( 21 )$$

At the same time, the 2×1 binaural response e produced at the listener's ears by the loudspeakers is modelled as a 2×M acoustic transmission matrix H multiplied with the M×1 vector g of complex speaker activation values:

$$e = Hg \qquad ( 22 )$$

The acoustic transmission matrix H is modelled based on the set of loudspeaker positions {\vec{s}ᵢ} with respect to the listener position. Finally, the spatial component of the cost function is defined as the squared error between the desired binaural response (Equation 5) and that produced by the loudspeakers (Equation 6):

$${C}_{spatial} ( g , \vec{o} , \{ {\vec{s}}_{i} \} ) = ( b - Hg ) * ( b - Hg ) \qquad ( 23 )$$

Conveniently, the spatial term of the cost function for CMAP and FV defined in Equations 4 and 7 can both be rearranged into a matrix quadratic as a function of speaker activations g:

$${C}_{spatial} ( g , \vec{o} , \{ {\vec{s}}_{i} \} ) = g * Ag + Bg + C \qquad ( 24 )$$

where A is an M×M square matrix, B is a 1×M vector, and C is a scalar. The matrix A is of rank 2, and therefore when M>2 there exist an infinite number of speaker activations g for which the spatial error term equals zero. Introducing the second term of the cost function, C_{proximity}, removes this indeterminacy and results in a particular solution with perceptually beneficial properties in comparison to the other possible solutions. For both CMAP and FV, C_{proximity} is constructed such that activation of speakers whose position \vec{s}ᵢ is distant from the desired audio signal position \vec{o} is penalized more than activation of speakers whose position is close to the desired position. This construction yields an optimal set of speaker activations that is sparse, where only speakers in close proximity to the desired audio signal's position are significantly activated, and practically results in a spatial reproduction of the audio signal that is perceptually more robust to listener movement around the set of speakers.

To this end, the second term of the cost function, C_{proximity}, may be defined as a distance-weighted sum of the absolute values squared of speaker activations. This is represented compactly in matrix form as:

$${C}_{proximity} ( g , \vec{o} , \{ {\vec{s}}_{i} \} ) = g * Dg \qquad ( 25 a )$$

where D is a diagonal matrix of distance penalties between the desired audio position and each speaker:

$$D = [ \begin{matrix}{d}_{1} & … & 0 \\ ⋮ & ⋱ & ⋮ \\ 0 & … & {d}_{M}\end{matrix} ] , {d}_{i} = distance ( \vec{o} , {\vec{s}}_{i} ) \qquad ( 25 b )$$

The distance penalty function can take on many forms, but the following is a useful parameterization

$$distance ( \vec{o} , {\vec{s}}_{i} ) = α {{d}_{0}^{2} ( \frac{‖ \vec{o} - {\vec{s}}_{i} ‖}{{d}_{0}} )}^{β} \qquad ( 25 c )$$

where ∥\vec{o}−\vec{s}ᵢ∥ is the Euclidean distance between the desired audio position and speaker position and α and β are tunable parameters. The parameter α indicates the global strength of the penalty; d₀ corresponds to the spatial extent of the distance penalty (loudspeakers at a distance around d₀ or further away will be penalized), and β accounts for the abruptness of the onset of the penalty at distance d₀.

Combining the two terms of the cost function defined in Equations 8 and 9a yields the overall cost function

$$C ( g ) = g * Ag + Bg + C + g * Dg = g * ( A + D ) g + Bg + C \qquad ( 26 )$$

Setting the derivative of this cost function with respect to g equal to zero and solving for g yields the optimal speaker activation solution:

$${g}_{opt} = \frac{1}{2} {( A + D )}^{- 1} B \qquad ( 27 )$$

In general, the optimal solution in Equation 27 may yield speaker activations that are negative in value. For the CMAP construction of the flexible renderer, such negative activations may not be desirable, and thus Equation 27 may be minimized subject to all activations remaining positive.

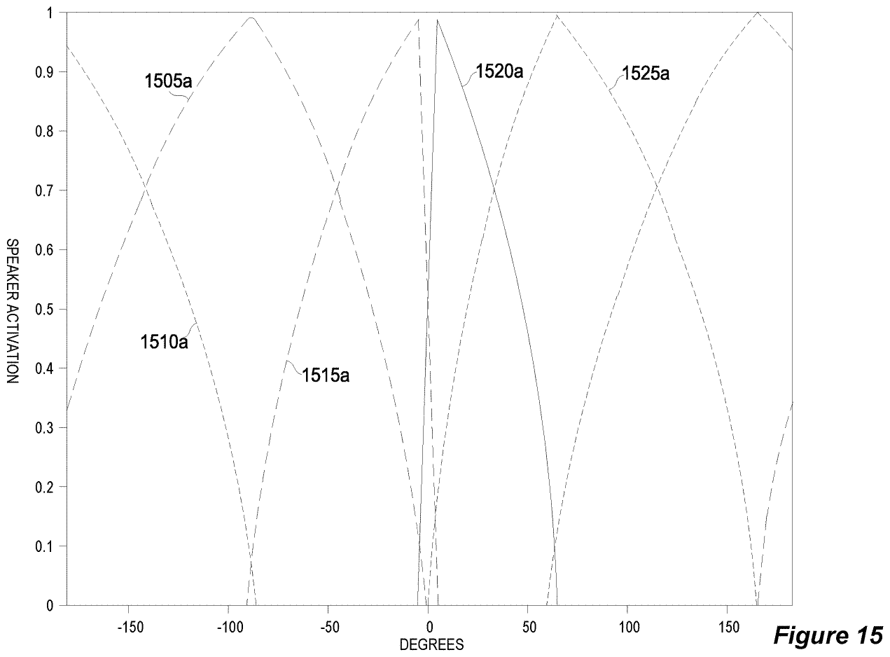

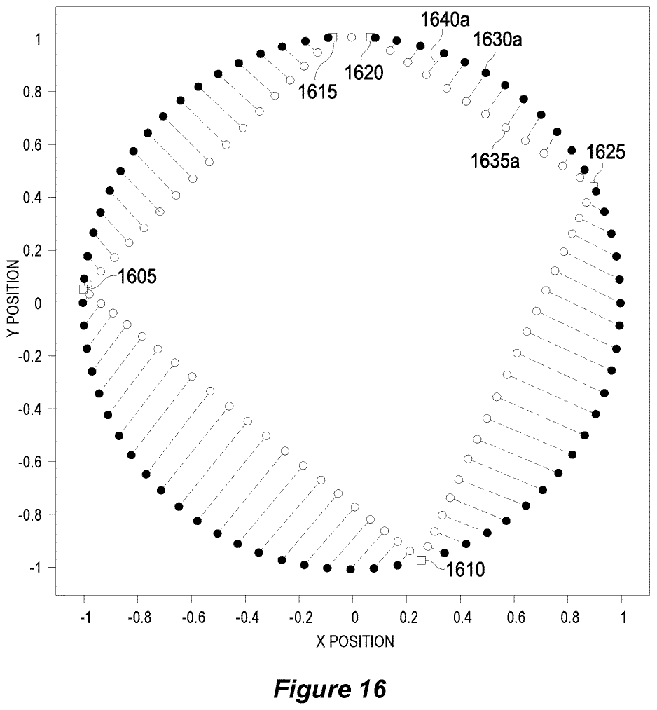

FIGS. 15 and 16 are diagrams which illustrate an example set of speaker activations and object rendering positions. In these examples, the speaker activations and object rendering positions correspond to speaker positions of 4, 64, 165, −87, and −4 degrees. FIG. 15 shows the speaker activations 1505a, 1510a, 1515a, 1520a and 1525a, which comprise the optimal solution to Equation 11 for these particular speaker positions. FIG. 16 plots the individual speaker positions as dots 1605, 1610, 1615, 1620 and 1625, which correspond to speaker activations 1505a, 1510a, 1515a, 1520a and 1525a, respectively. FIG. 16 also shows ideal object positions (in other words, positions at which audio objects are to be rendered) for a multitude of possible object angles as dots 1630a and the corresponding actual rendering positions for those objects as dots 1635a, connected to the ideal object positions by dotted lines 1640a.

A class of embodiments involves methods for rendering audio for playback by at least one (e.g., all or some) of a plurality of coordinated (orchestrated) smart audio devices. For example, a set of smart audio devices present (in a system) in a user's home may be orchestrated to handle a variety of simultaneous use cases, including flexible rendering (in accordance with an embodiment) of audio for playback by all or some (i.e., by speaker(s) of all or some) of the smart audio devices. Many interactions with the system are contemplated which require dynamic modifications to the rendering. Such modifications may be, but are not necessarily, focused on spatial fidelity.

Some embodiments are methods for rendering of audio for playback by at least one (e.g., all or some) of the smart audio devices of a set of smart audio devices (or for playback by at least one (e.g., all or some) of the speakers of another set of speakers). The rendering may include minimization of a cost function, where the cost function includes at least one dynamic speaker activation term. Examples of such a dynamic speaker activation term include (but are not limited to):
Proximity of speakers to one or more listeners;
Proximity of speakers to an attracting or repelling force;
Audibility of the speakers with respect to some location (e.g., listener position, or baby room);
Capability of the speakers (e.g., frequency response and distortion);
Synchronization of the speakers with respect to other speakers;
Wakeword performance; and
Echo canceller performance.

The dynamic speaker activation term(s) may enable at least one of a variety of behaviors, including warping the spatial presentation of the audio away from a particular smart audio device so that its microphone can better hear a talker or so that a secondary audio stream may be better heard from speaker(s) of the smart audio device.

Some embodiments implement rendering for playback by speaker(s) of a plurality of smart audio devices that are coordinated (orchestrated). Other embodiments implement rendering for playback by speaker(s) of another set of speakers.

Pairing flexible rendering methods (implemented in accordance with some embodiments) with a set of wireless smart speakers (or other smart audio devices) can yield an extremely capable and easy-to-use spatial audio rendering system. In contemplating interactions with such a system it becomes evident that dynamic modifications to the spatial rendering may be desirable in order to optimize for other objectives that may arise during the system's use. To achieve this goal, a class of embodiments augment existing flexible rendering algorithms (in which speaker activation is a function of the previously disclosed spatial and proximity terms), with one or more additional dynamically configurable functions dependent on one or more properties of the audio signals being rendered, the set of speakers, and/or other external inputs. In accordance with some embodiments, the cost function of the existing flexible rendering given in Equation 1 is augmented with these one or more additional dependencies according to

$$C ( g ) = {C}_{spatial} ( g , \vec{o} , \{ {\vec{s}}_{i} \} ) + {C}_{proximity} ( g , \vec{o} , \{ {\vec{s}}_{i} \} ) + {\sum }_{j} {C}_{j} ( g , {\{ \{ \hat{o} \} , \{ {\hat{s}}_{i} \} , \{ \hat{e} \} \}}_{j} ) \qquad ( 28 )$$

In Equation 28, the terms Cⱼ (g, {{ô}, {ŝᵢ}, {ê}}ⱼ) represent additional cost terms, with {ô} representing a set of one or more properties of the audio signals (e.g., of an object-based audio program) being rendered, {ŝᵢ} representing a set of one or more properties of the speakers over which the audio is being rendered, and {ê} representing one or more additional external inputs. Each term Cⱼ (g, {{ô}, {ŝᵢ}, {ê}}ⱼ) returns a cost as a function of activations g in relation to a combination of one or more properties of the audio signals, speakers, and/or external inputs, represented generically by the set {{ô}, {ŝᵢ}, {ê}}ⱼ. It should be appreciated that the set {{ô}, {ŝᵢ}, {ê}}ⱼ contains at a minimum only one element from any of {ô}, {ŝᵢ}, or {ê}.

Examples of {ô} include but are not limited to:
Desired perceived spatial position of the audio signal;
Level (possible time-varying) of the audio signal; and/or
Spectrum (possibly time-varying) of the audio signal.

Examples of {ŝᵢ} include but are not limited to:
Locations of the loudspeakers in the listening space;
Frequency response of the loudspeakers;
Playback level limits of the loudspeakers;
Parameters of dynamics processing algorithms within the speakers, such as limiter gains;
A measurement or estimate of acoustic transmission from each speaker to the others;
A measure of echo canceller performance on the speakers; and/or
· Relative synchronization of the speakers with respect to each other.

Examples of {ê} include but are not limited to:
Locations of one or more listeners or talkers in the playback space;
A measurement or estimate of acoustic transmission from each loudspeaker to the listening location;
A measurement or estimate of the acoustic transmission from a talker to the set of loudspeakers;
Location of some other landmark in the playback space; and/or
A measurement or estimate of acoustic transmission from each speaker to some other landmark in the playback space;

With the new cost function defined in Equation 28, an optimal set of activations may be found through minimization with respect to g and possible post-normalization as previously specified in Equations 28a and 28b.

In some examples, one or more of the cost terms Cⱼ may be determined by a ducking module, such as the ducking module 400 of FIG. 6, as a function of one or more {ŝᵢ} terms, one or more {ê} terms, or a combination thereof. In some such examples, the ducking solution 480 that is provided to a renderer may include one or more of such terms. In other examples, one or more of such terms may be determined by a renderer. In some such examples, one or more of such terms may be determined by a renderer responsive to the ducking solution 480. According to some examples, one or more of such terms may be determined according to an iterative process, such as method 800 of FIG. 8.

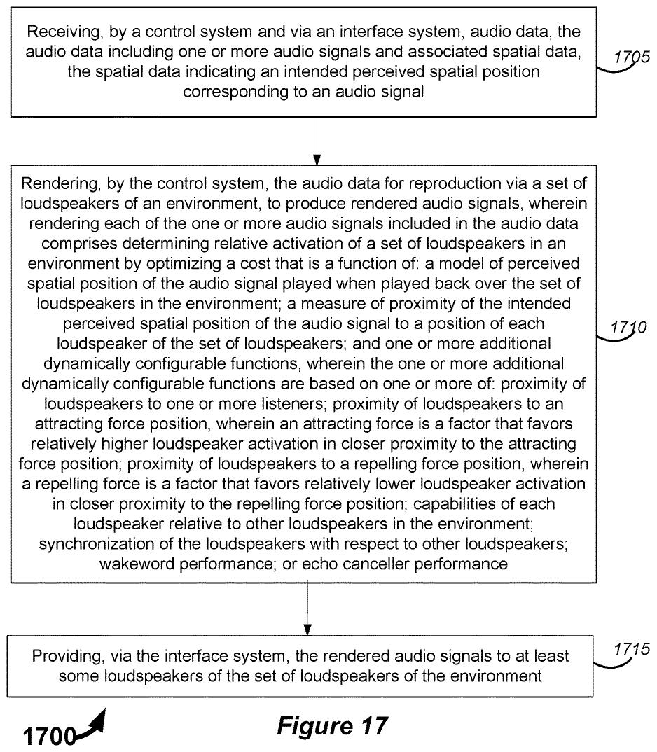

FIG. 17 is a flow diagram that outlines one example of a method that may be performed by an apparatus or system such as that shown in FIG. 1A. The blocks of method 1700, like other methods described herein, are not necessarily performed in the order indicated. Moreover, such methods may include more or fewer blocks than shown and/or described. The blocks of method 1700 may be performed by one or more devices, which may be (or may include) a control system such as the control system 160 shown in FIG. 1A.

In this implementation, block 1705 involves receiving, by a control system and via an interface system, audio data. In this example, the audio data includes one or more audio signals and associated spatial data. According to this implementation, the spatial data indicates an intended perceived spatial position corresponding to an audio signal. In some instances, the intended perceived spatial position may be explicit, e.g., as indicated by positional metadata such as Dolby Atmos positional metadata. In other instances, the intended perceived spatial position may be implicit, e.g., the intended perceived spatial position may be an assumed location associated with a channel according to Dolby 5.1, Dolby 7.1, or another channel-based audio format. In some examples, block 1705 involves a rendering module of a control system receiving, via an interface system, the audio data.

According to this example, block 1710 involves rendering, by the control system, the audio data for reproduction via a set of loudspeakers of an environment, to produce rendered audio signals. In this example, rendering each of the one or more audio signals included in the audio data involves determining relative activation of a set of loudspeakers in an environment by optimizing a cost function. According to this example, the cost is a function of a model of perceived spatial position of the audio signal when played back over the set of loudspeakers in the environment. In this example, the cost is also a function of a measure of proximity of the intended perceived spatial position of the audio signal to a position of each loudspeaker of the set of loudspeakers. In this implementation, the cost is also a function of one or more additional dynamically configurable functions. In this example, the dynamically configurable functions are based on one or more of the following: proximity of loudspeakers to one or more listeners; proximity of loudspeakers to an attracting force position, wherein an attracting force is a factor that favors relatively higher loudspeaker activation in closer proximity to the attracting force position; proximity of loudspeakers to a repelling force position, wherein a repelling force is a factor that favors relatively lower loudspeaker activation in closer proximity to the repelling force position; capabilities of each loudspeaker relative to other loudspeakers in the environment; synchronization of the loudspeakers with respect to other loudspeakers; wakeword performance; or echo canceller performance.

In this example, block 1715 involves providing, via the interface system, the rendered audio signals to at least some loudspeakers of the set of loudspeakers of the environment.

According to some examples, the model of perceived spatial position may produce a binaural response corresponding to an audio object position at the left and right ears of a listener. Alternatively, or additionally, the model of perceived spatial position may place the perceived spatial position of an audio signal playing from a set of loudspeakers at a center of mass of the set of loudspeakers' positions weighted by the loudspeaker's associated activating gains.

In some examples, the one or more additional dynamically configurable functions may be based, at least in part, on a level of the one or more audio signals. In some instances, the one or more additional dynamically configurable functions may be based, at least in part, on a spectrum of the one or more audio signals.

Some examples of the method 1700 involve receiving loudspeaker layout information. In some examples, the one or more additional dynamically configurable functions may be based, at least in part, on a location of each of the loudspeakers in the environment.

Some examples of the method 1700 involve receiving loudspeaker specification information. In some examples, the one or more additional dynamically configurable functions may be based, at least in part, on the capabilities of each loudspeaker, which may include one or more of frequency response, playback level limits or parameters of one or more loudspeaker dynamics processing algorithms.

According to some examples, the one or more additional dynamically configurable functions may be based, at least in part, on a measurement or estimate of acoustic transmission from each loudspeaker to the other loudspeakers. Alternatively, or additionally, the one or more additional dynamically configurable functions may be based, at least in part, on a listener or speaker location of one or more people in the environment. Alternatively, or additionally, the one or more additional dynamically configurable functions may be based, at least in part, on a measurement or estimate of acoustic transmission from each loudspeaker to the listener or speaker location. An estimate of acoustic transmission may, for example be based at least in part on walls, furniture or other objects that may reside between each loudspeaker and the listener or speaker location.

Alternatively, or additionally, the one or more additional dynamically configurable functions may be based, at least in part, on an object location of one or more non-loudspeaker objects or landmarks in the environment. In some such implementations, the one or more additional dynamically configurable functions may be based, at least in part, on a measurement or estimate of acoustic transmission from each loudspeaker to the object location or landmark location.

Numerous new and useful behaviors may be achieved by employing one or more appropriately defined additional cost terms to implement flexible rendering. All example behaviors listed below are cast in terms of penalizing certain loudspeakers under certain conditions deemed undesirable. The end result is that these loudspeakers are activated less in the spatial rendering of the set of audio signals. In many of these cases, one might contemplate simply turning down the undesirable loudspeakers independently of any modification to the spatial rendering, but such a strategy may significantly degrade the overall balance of the audio content. Certain components of the mix may become completely inaudible, for example. With the disclosed embodiments, on the other hand, integration of these penalizations into the core optimization of the rendering allows the rendering to adapt and perform the best possible spatial rendering with the remaining less-penalized speakers. This is a much more elegant, adaptable, and effective solution.

Example use cases include, but are not limited to:
Providing a more balanced spatial presentation around the listening area
   It has been found that spatial audio is best presented across loudspeakers that are roughly the same distance from the intended listening area. A cost may be constructed such that loudspeakers that are significantly closer or further away than the mean distance of loudspeakers to the listening area are penalized, thus reducing their activation;
Moving audio away from or towards a listener or talker
   If a user of the system is attempting to speak to a smart voice assistant of or associated with the system, it may be beneficial to create a cost which penalizes loudspeakers closer to the talker. This way, these loudspeakers are activated less, allowing their associated microphones to better hear the talker;
   To provide a more intimate experience for a single listener that minimizes playback levels for others in the listening space, speakers far from the listener's location may be penalized heavily so that only speakers closest to the listener are activated most significantly;
Moving audio away from or towards a landmark, zone or area
   Certain locations in the vicinity of the listening space may be considered sensitive, such as a baby's room, a baby's bed, an office, a reading area, a study area, etc. In such a case, a cost may be constructed the penalizes the use of speakers close to this location, zone or area;
   Alternatively, for the same case above (or similar cases), the system of speakers may have generated measurements of acoustic transmission from each speaker into the baby's room, particularly if one of the speakers (with an attached or associated microphone) resides within the baby's room itself. In this case, rather than using physical proximity of the speakers to the baby's room, a cost may be constructed that penalizes the use of speakers whose measured acoustic transmission into the room is high; and/or
Optimal use of the speakers' capabilities
   The capabilities of different loudspeakers can vary significantly. For example, one popular smart speaker contains only a single 1.6″ full range driver with limited low frequency capability. On the other hand, another smart speaker contains a much more capable 3″ woofer. These capabilities are generally reflected in the frequency response of a speaker, and as such, the set of responses associated with the speakers may be utilized in a cost term. At a particular frequency, speakers that are less capable relative to the others, as measured by their frequency response, may be penalized and therefore activated to a lesser degree. In some implementations, such frequency response values may be stored with a smart loudspeaker and then reported to the computational unit responsible for optimizing the flexible rendering;
   Many speakers contain more than one driver, each responsible for playing a different frequency range. For example, one popular smart speaker is a two-way design containing a woofer for lower frequencies and a tweeter for higher frequencies. Typically, such a speaker contains a crossover circuit to divide the full-range playback audio signal into the appropriate frequency ranges and send to the respective drivers. Alternatively, such a speaker may provide the flexible renderer playback access to each individual driver as well as information about the capabilities of each individual driver, such as frequency response. By applying a cost term such as that described just above, in some examples the flexible renderer may automatically build a crossover between the two drivers based on their relative capabilities at different frequencies;
   The above-described example uses of frequency response focus on the inherent capabilities of the speakers but may not accurately reflect the capability of the speakers as placed in the listening environment. In certain cases, the frequencies responses of the speakers as measured in the intended listening position may be available through some calibration procedure. Such measurements may be used instead of precomputed responses to better optimize use of the speakers. For example, a certain speaker may be inherently very capable at a particular frequency, but because of its placement (behind a wall or a piece of furniture for example) might produce a very limited response at the intended listening position. A measurement that captures this response and is fed into an appropriate cost term can prevent significant activation of such a speaker;
   Frequency response is only one aspect of a loudspeaker's playback capabilities. Many smaller loudspeakers start to distort and then hit their excursion limit as playback level increases, particularly for lower frequencies. To reduce such distortion many loudspeakers implement dynamics processing which constrains the playback level below some limit thresholds that may be variable across frequency. In cases where a speaker is near or at these thresholds, while others participating in flexible rendering are not, it makes sense to reduce signal level in the limiting speaker and divert this energy to other less taxed speakers. Such behavior can be automatically achieved in accordance with some embodiments by properly configuring an associated cost term. Such a cost term may involve one or more of the following:
      Monitoring a global playback volume in relation to the limit thresholds of the loudspeakers. For example, a loudspeaker for which the volume level is closer to its limit threshold may be penalized more;
      Monitoring dynamic signals levels, possibly varying across frequency, in relationship to loudspeaker limit thresholds, also possibly varying across frequency. For example, a loudspeaker for which the monitored signal level is closer to its limit thresholds may be penalized more;
      Monitoring parameters of the loudspeakers' dynamics processing directly, such as limiting gains. In some such examples, a loudspeaker for which the parameters indicate more limiting may be penalized more; and/or
      Monitoring the actual instantaneous voltage, current, and power being delivered by an amplifier to a loudspeaker to determine if the loudspeaker is operating in a linear range. For example, a loudspeaker which is operating less linearly may be penalized more;
   Smart speakers with integrated microphones and an interactive voice assistant typically employ some type of echo cancellation to reduce the level of audio signal playing out of the speaker as picked up by the recording microphone. The greater this reduction, the better chance the speaker has of hearing and understanding a talker in the space. If the residual of the echo canceller is consistently high, this may be an indication that the speaker is being driven into a non-linear region where prediction of the echo path becomes challenging. In such a case it may make sense to divert signal energy away from the speaker, and as such, a cost term taking into account echo canceller performance may be beneficial. Such a cost term may assign a high cost to a speaker for which its associated echo canceller is performing poorly;
   In order to achieve predictable imaging when rendering spatial audio over multiple loudspeakers, it is generally required that playback over the set of loudspeakers be reasonably synchronized across time. For wired loudspeakers this is a given, but with a multitude of wireless loudspeakers synchronization may be challenging and the end-result variable. In such a case it may be possible for each loudspeaker to report its relative degree of synchronization with a target, and this degree may then feed into a synchronization cost term. In some such examples, loudspeakers with a lower degree of synchronization may be penalized more and therefore excluded from rendering. Additionally, tight synchronization may not be required for certain types of audio signals, for example components of the audio mix intended to be diffuse or non-directional. In some implementations, components may be tagged as such with metadata and a synchronization cost term may be modified such that the penalization is reduced.

We next describe additional examples of embodiments. Similar to the proximity cost defined in Equations 25a and 25b, it may also be convenient to express each of the new cost function terms Cⱼ (g, {{ô}, {ŝᵢ}, {ê}}ⱼ) as a weighted sum of the absolute values squared of speaker activations, e.g. as follows:

$${C}_{j} ( g , {\{ \{ \hat{o} \} , \{ {\hat{s}}_{i} \} , \{ \hat{e} \} \}}_{j} ) = g * {W}_{j} ( {\{ \{ \hat{o} \} , \{ {\hat{s}}_{i} \} , \{ \hat{e} \} \}}_{j} ) g , \qquad ( 29 a )$$

where Wⱼ is a diagonal matrix of weights wᵢⱼ=wᵢⱼ({{ô}, {ŝᵢ}, {ê}}ⱼ) describing the cost associated with activating speaker i for the term j:

$${W}_{j} = [ \begin{matrix}{w}_{1 j} & ⋯ & 0 \\ ⋮ & ⋱ & ⋮ \\ 0 & ⋯ & {w}_{Mj}\end{matrix} ] \qquad ( 29 b )$$

Combining Equations 29a and 29b with the matrix quadratic version of the CMAP and FV cost functions given in Equation 26 yields a potentially beneficial implementation of the general expanded cost function (of some embodiments) given in Equation 28:

$$C ( g ) = g * Ag + Bg + C + g * Dg + {\sum }_{j} g * {W}_{j} g = g * ( A + D + {\sum }_{j} {W}_{j} ) g + Bg + C \qquad ( 30 )$$

With this definition of the new cost function terms, the overall cost function remains a matrix quadratic, and the optimal set of activations gₒₚₜ can be found through differentiation of Equation 30 to yield

$${g}_{opt} = \frac{1}{2} {( A + D + {\sum }_{j} {W}_{j} )}^{- 1} B \qquad ( 31 )$$

It is useful to consider each one of the weight terms wij as functions of a given continuous penalty value pᵢⱼ=pᵢⱼ({{ô}, {ŝᵢ}, {ê}}ⱼ) for each one of the loudspeakers. In one example embodiment, this penalty value is the distance from the object (to be rendered) to the loudspeaker considered. In another example embodiment, this penalty value represents the inability of the given loudspeaker to reproduce some frequencies. Based on this penalty value, the weight terms wᵢⱼ can be parametrized as:

$${w}_{ij} = {α}_{j} {f}_{j} ( \frac{{p}_{ij}}{{τ}_{j}} ) \qquad ( 32 )$$

where αⱼ represents a pre-factor (which takes into account the global intensity of the weight term), where τⱼ represents a penalty threshold (around or beyond which the weight term becomes significant), and where fⱼ(x) represents a monotonically increasing function. For example, with fⱼ(x)=x^{β}^{ⱼ} the weight term has the form:

$${w}_{ij} = {{α}_{j} ( \frac{{p}_{ij}}{{τ}_{j}} )}^{{β}_{j}} \qquad ( 33 )$$

where αⱼ, βⱼ, τⱼ are tunable parameters which respectively indicate the global strength of the penalty, the abruptness of the onset of the penalty and the extent of the penalty. Care should be taken in setting these tunable values so that the relative effect of the cost term Cⱼ with respect any other additional cost terms as well as Cₛₚₐₜᵢₐₗ and C_{proximity} is appropriate for achieving the desired outcome. For example, as a rule of thumb, if one desires a particular penalty to clearly dominate the others then setting its intensity a roughly ten times larger than the next largest penalty intensity may be appropriate.

In case all loudspeakers are penalized, it is often convenient to subtract the minimum penalty from all weight terms in post-processing so that at least one of the speakers is not penalized:

$${w}_{ij} \to {w}_{ij}^{′} = {w}_{ij} - {min}_{i} ( {w}_{ij} ) \qquad ( 34 )$$

As stated above, there are many possible use cases that can be realized using the new cost function terms described herein (and similar new cost function terms employed in accordance with other embodiments). Next, we describe more concrete details with three examples: moving audio towards a listener or talker, moving audio away from a listener or talker, and moving audio away from a landmark.

In the first example, what will be referred to herein as an “attracting force” is used to pull audio towards a position, which in some examples may be the position of a listener or a talker a landmark position, a furniture position, etc. The position may be referred to herein as an “attracting force position” or an “attractor location.” As used herein an “attracting force” is a factor that favors relatively higher loudspeaker activation in closer proximity to an attracting force position. According to this example, the weight wᵢⱼ takes the form of equation 17 with the continuous penalty value pᵢⱼ given by the distance of the ith speaker from a fixed attractor location \vec{l}ⱼ and the threshold value τⱼ given by the maximum of these distances across all speakers:

$${p}_{ij} = ‖ \vec{{l}_{j}} - {\vec{s}}_{i} ‖ , and \qquad ( 35 a )$$

$${τ}_{j} = {max}_{i} ‖ \vec{{l}_{j}} - {\vec{s}}_{i} ‖ \qquad ( 35 b )$$

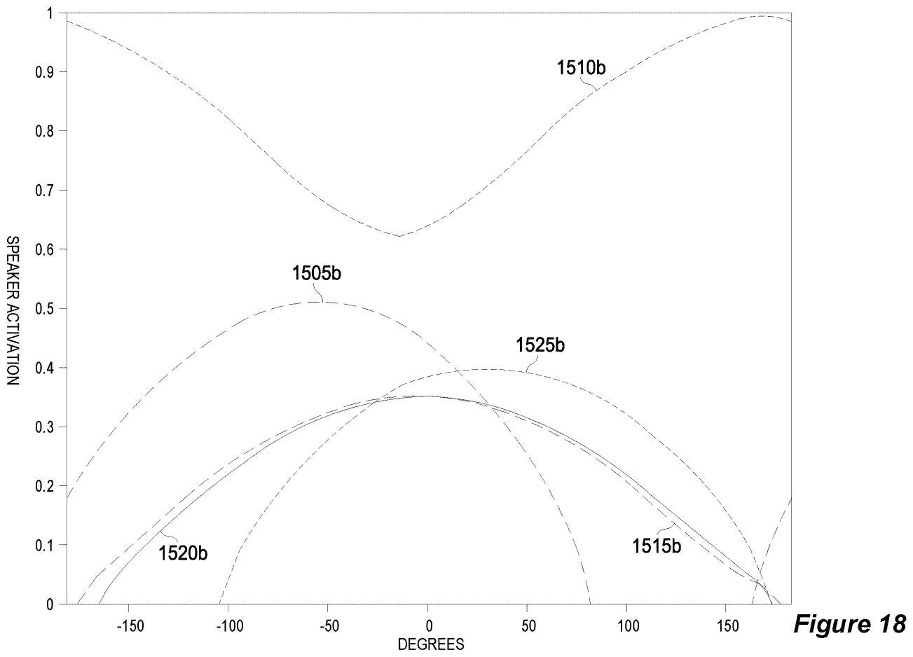

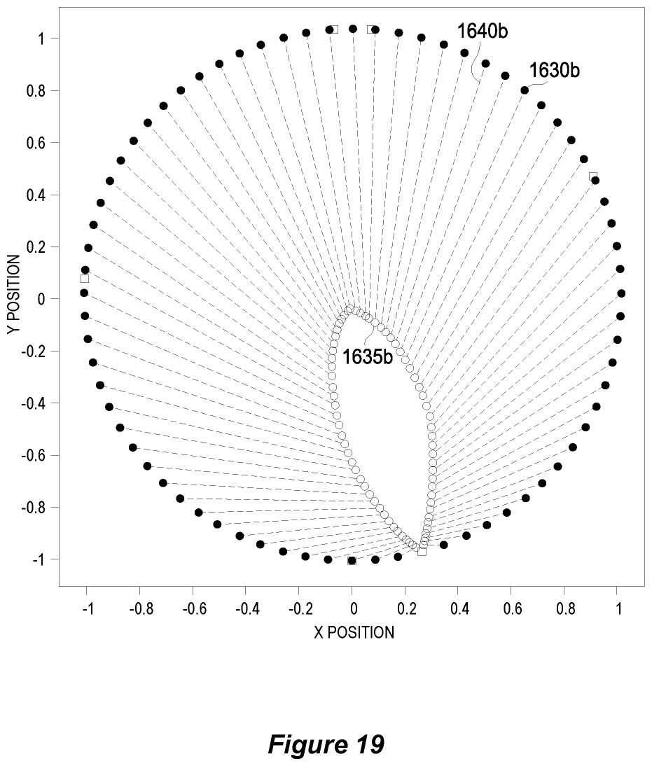

To illustrate the use case of “pulling” audio towards a listener or talker, we specifically set αⱼ=20, βⱼ=3, and \vec{l}ⱼ to a vector corresponding to a listener/talker position of 180 degrees (bottom, center of the plot). These values of αⱼ, βⱼ, and \vec{l}ⱼ are merely examples. In some implementations, αⱼ may be in the range of 1 to 100 and βⱼ may be in the range of 1 to 25. FIG. 18 is a graph of speaker activations in an example embodiment. In this example, FIG. 18 shows the speaker activations 1505b, 1510b, 1515b, 1520b and 1525b, which comprise the optimal solution to the cost function for the same speaker positions from FIGS. 15 and 16, with the addition of the attracting force represented by wᵢⱼ. FIG. 19 is a graph of object rendering positions in an example embodiment. In this example, FIG. 19 shows the corresponding ideal object positions 1630b for a multitude of possible object angles and the corresponding actual rendering positions 1635b for those objects, connected to the ideal object positions 1630b by dotted lines 1640b. The skewed orientation of the actual rendering positions 1635b towards the fixed position \vec{l}ⱼ illustrates the impact of the attractor weightings on the optimal solution to the cost function.

In the second and third examples, a “repelling force” is used to “push” audio away from a position, which may be a person's position (e.g., a listener position, a talker position, etc.) or another position, such as a landmark position, a furniture position, etc. In some examples, a repelling force may be used to push audio away from an area or zone of a listening environment, such as an office area, a reading area, a bed or bedroom area (e.g., a baby's bed or bedroom), etc. According to some such examples, a particular position may be used as representative of a zone or area. For example, a position that represents a baby's bed may be an estimated position of the baby's head, an estimated sound source location corresponding to the baby, etc. The position may be referred to herein as a “repelling force position” or a “repelling location.” As used herein an “repelling force” is a factor that favors relatively lower loudspeaker activation in closer proximity to the repelling force position. According to this example, we define pᵢⱼ and τⱼ with respect to a fixed repelling location \vec{l}ⱼ similarly to the attracting force in Equations 35a and 35b:

$${p}_{ij} = {max}_{i} ‖ \vec{{l}_{j}} - {\vec{s}}_{i} ‖ - ‖ \vec{{l}_{j}} - {\vec{s}}_{i} ‖ , and \qquad ( 35 c )$$

$${τ}_{j} = {max}_{i} ‖ \vec{{l}_{j}} - {\vec{s}}_{i} ‖ \qquad ( 35 d )$$

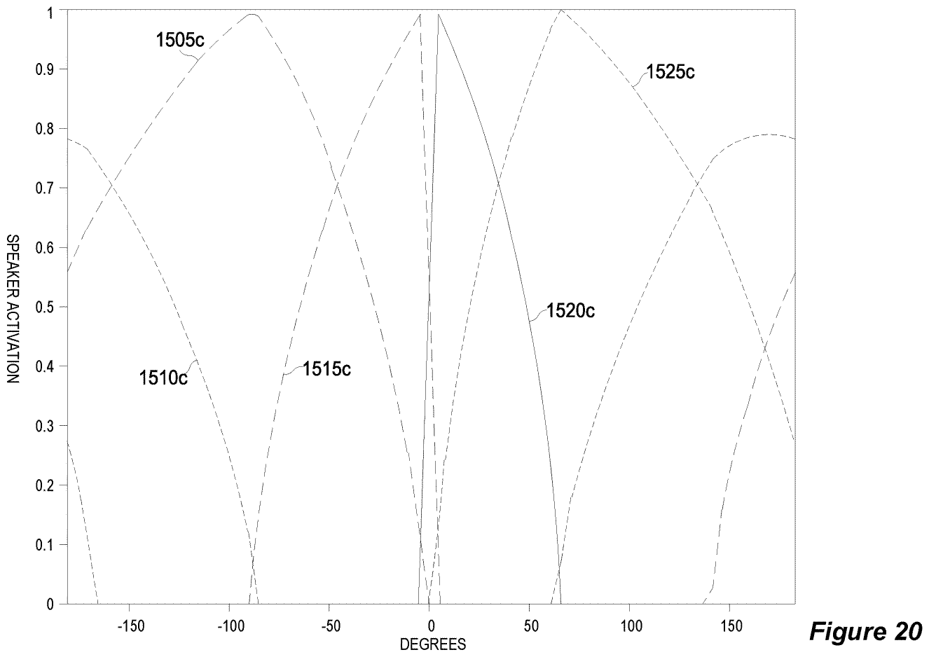

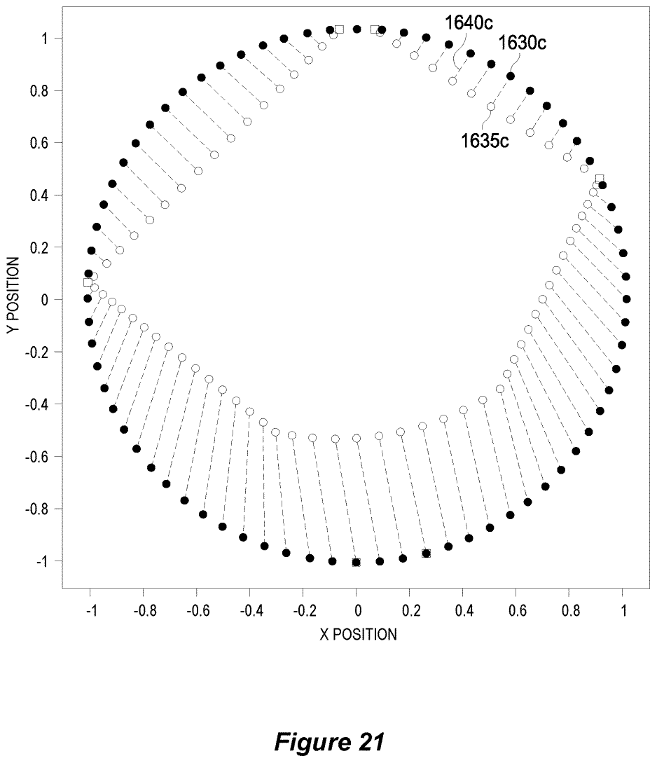

To illustrate the use case of pushing audio away from a listener or talker, in one example we may specifically set αⱼ=5, βⱼ=2, and \vec{l}ⱼ to a vector corresponding to a listener/talker position of 180 degrees (at the bottom, center of the plot). These values of αⱼ, βⱼ, and \vec{l}ⱼ are merely examples. As noted above, in some examples αⱼ may be in the range of 1 to 100 and βⱼ may be in the range of 1 to 25. FIG. 20 is a graph of speaker activations in an example embodiment. According to this example, FIG. 20 shows the speaker activations 1505c, 1510c, 1515c, 1520c and 1525c, which comprise the optimal solution to the cost function for the same speaker positions as previous figures, with the addition of the repelling force represented by wᵢⱼ. FIG. 21 is a graph of object rendering positions in an example embodiment. In this example, FIG. 21 shows the ideal object positions 1630c for a multitude of possible object angles and the corresponding actual rendering positions 1635c for those objects, connected to the ideal object positions 1630c by dotted lines 1640c. The skewed orientation of the actual rendering positions 1635c away from the fixed position \vec{l}ⱼ illustrates the impact of the repeller weightings on the optimal solution to the cost function.

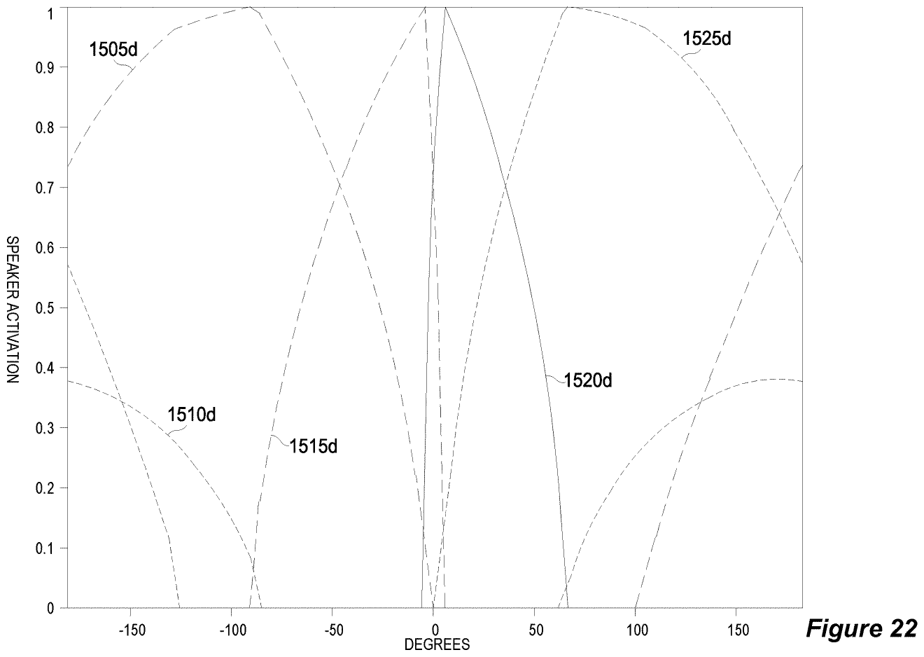

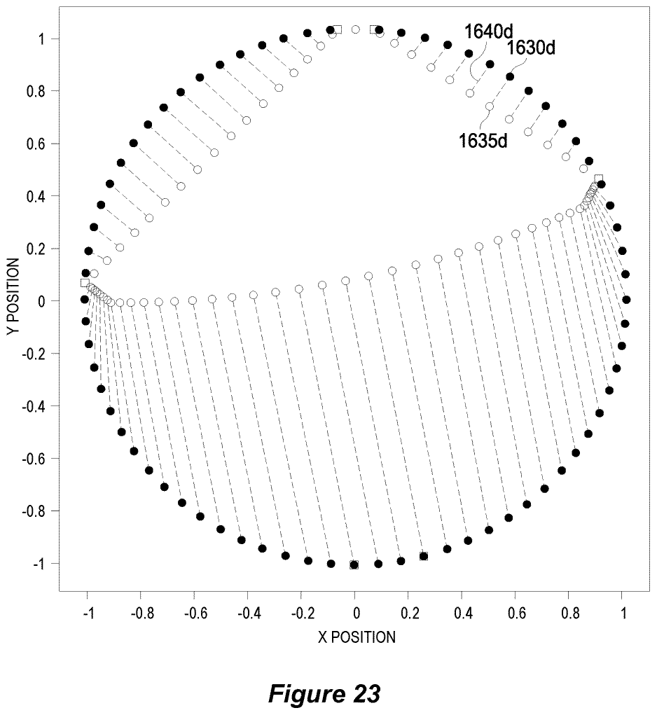

The third example use case is “pushing” audio away from a landmark which is acoustically sensitive, such as a door to a sleeping baby's room. Similarly to the last example, we set \vec{l}ⱼ to a vector corresponding to a door position of 180 degrees (bottom, center of the plot). To achieve a stronger repelling force and skew the soundfield entirely into the front part of the primary listening space, we set αⱼ=20, βⱼ=5. FIG. 22 is a graph of speaker activations in an example embodiment. Again, in this example FIG. 22 shows the speaker activations 1505d, 1510d, 1515d, 1520d and 1525d, which comprise the optimal solution to the same set of speaker positions with the addition of the stronger repelling force. FIG. 23 is a graph of object rendering positions in an example embodiment. And again, in this example FIG. 23 shows the ideal object positions 1630d for a multitude of possible object angles and the corresponding actual rendering positions 1635d for those objects, connected to the ideal object positions 1630d by dotted lines 1640d. The skewed orientation of the actual rendering positions 1635d illustrates the impact of the stronger repeller weightings on the optimal solution to the cost function.

In a further example of the method 1700 of FIG. 17, the use case is responding to a selection of two or more audio devices in the audio environment for ducking, or for other audio processing corresponding to a ducking solution, and applying a penalty to the two or more audio devices corresponding to a ducking solution. According to a previous example, the selection of two or more audio devices could in some embodiments take the form of values fᵢ, unitless parameters that control the degree to which audio processing changes occur on audio device i. Many combinations are possible. In one simple example, the penalty assigned to audio device i for the purposes of ducking may be selected directly as wᵢⱼ=fᵢ. In some examples, one or more of such weights may be determined by a ducking module, such as the ducking module 400 of FIG. 6. In some such examples, the ducking solution 480 that is provided to a renderer may include one or more of such weights. In other examples, these weights may be determined by a renderer. In some such examples, one or more of such weights may be determined by a renderer responsive to the ducking solution 480. According to some examples, one or more of such weights may be determined according to an iterative process, such as method 800 of FIG. 8.

Further to previous examples of determining weights, in some implementations, weights may be determined as follows:

$${w}_{ij} = {{α}_{j} ( \frac{{f}_{i}}{{τ}_{j}} )}^{{β}_{j}}$$

In the foregoing equation, αⱼ, βⱼ, τⱼ represent tunable parameters which respectively indicate the global strength of the penalty, the abruptness of the onset of the penalty and the extent of the penalty, as described above with reference to Equation 33.

Previous examples also introduced sᵢ, expressed directly in speech to echo ratio improvement decibels at audio device i, as an alternative to the unitless parameters fᵢ describing the ducking solution. Representing the solution this way, penalties may alternatively be determined as follows:

$${w}_{ij} = {{α}_{j} ( \frac{1 {0}^{- \frac{{s}_{i}}{20}}}{{τ}_{j}} )}^{{β}_{j}}$$

Here fᵢ has been replaced by a conversion of the dB terms sᵢ to values ranging from 0 to infinity. As sᵢ becomes increasingly negative, the penalty increases, thereby moving more audio from device i.

In some examples (such as those of the previous two equations), one or more of the tunable parameters αⱼ, βⱼ, τⱼ may be determined by a ducking module, such as the ducking module 400 of FIG. 6. In some such examples, the ducking solution 480 that is provided to a renderer may include one or more of such tunable parameters. In other examples, one or more tunable parameters may be determined by a renderer. In some such examples, one or more tunable parameters may be determined by a renderer responsive to the ducking solution 480. According to some examples, one or more of such tunable parameters may be determined according to an iterative process, such as method 800 of FIG. 8.

The foregoing ducking penalties may be understood as part of a combination of multiple penalization terms, arising from multiple simultaneous use cases. For instance, audio could be “pushed away” from a sensitive landmark using a penalty as described in equations 35c-d, whilst still also being “pushed away” from a microphone location where it is desirable for the SER to be improved using the terms fᵢ or sᵢ as determined by the decision aspect.

Aspects of some disclosed implementations include a system or device configured (e.g., programmed) to perform one or more disclosed methods, and a tangible computer readable medium (e.g., a disc) which stores code for implementing one or more disclosed methods or steps thereof. For example, the system can be or include a programmable general purpose processor, digital signal processor, or microprocessor, programmed with software or firmware and/or otherwise configured to perform any of a variety of operations on data, including one or more disclosed methods or steps thereof. Such a general purpose processor may be or include a computer system including an input device, a memory, and a processing subsystem that is programmed (and/or otherwise configured) to perform one or more disclosed methods (or steps thereof) in response to data asserted thereto.

Some disclosed embodiments are implemented as a configurable (e.g., programmable) digital signal processor (DSP) that is configured (e.g., programmed and otherwise configured) to perform required processing on audio signal(s), including performance of one or more disclosed methods. Alternatively, some embodiments (or elements thereof) may be implemented as a general purpose processor (e.g., a personal computer (PC) or other computer system or microprocessor, which may include an input device and a memory) which is programmed with software or firmware and/or otherwise configured to perform any of a variety of operations including one or more disclosed methods or steps thereof. Alternatively, elements of some disclosed embodiments are implemented as a general purpose processor or DSP configured (e.g., programmed) to perform one or more disclosed methods or steps thereof, and the system also includes other elements (e.g., one or more loudspeakers and/or one or more microphones). A general purpose processor configured to perform one or more disclosed methods or steps thereof would typically be coupled to an input device (e.g., a mouse and/or a keyboard), a memory, and a display device.

Another aspect of some disclosed implementations is a computer readable medium (for example, a disc or other tangible storage medium) which stores code for performing (e.g., coder executable to perform) any embodiment of one or more disclosed methods or steps thereof.

While specific embodiments and applications have been described herein, it will be apparent to those of ordinary skill in the art that many variations on the embodiments and applications described herein are possible without departing from the scope of the material described and claimed herein. It should be understood that while certain implementations have been shown and described, the present disclosure is not to be limited to the specific embodiments described and shown or the specific methods described.

Various aspects of the present invention may be appreciated from the following enumerated example embodiments (EEEs):

EEE1. An audio processing method, comprising:
receiving, by a control system, output signals from one or more microphones in an audio environment, the output signals including signals corresponding to a current utterance of a person;
determining, by the control system, responsive to the output signals and based at least in part on audio device location information and echo management system information, one or more audio processing changes to apply to audio data being rendered to loudspeaker feed signals for two or more audio devices in the audio environment, the audio processing changes comprising a reduction in a loudspeaker reproduction level for one or more loudspeakers in the audio environment; and
causing, by the control system, the one or more types of audio processing changes to be applied.

EEE2. The method of EEE 1, wherein at least one of the one or more types of audio processing changes corresponds with an increased signal to echo ratio.

EEE3. The method of EEE 1 or EEE 2, wherein the echo management system information comprises a model of echo management system performance.

EEE4. The method of EEE 3, wherein the model of echo management system performance comprises an acoustic echo canceller (AEC) performance matrix.

EEE5. The method of EEE 3 or EEE 4, wherein the model of echo management system performance comprises a measure of expected echo return loss enhancement provided by an echo management system.

EEE6. The method of any one of EEEs 1-5, wherein the one or more types of audio processing changes are based at least in part on an acoustic model of inter-device echo and intra-device echo.

EEE7. The method of any one of EEEs 1-6, wherein the one or more types of audio processing changes are based at least in part on a mutual audibility matrix.

EEE8. The method of any one of EEEs 1-7, wherein the one or more types of audio processing changes are based at least in part on an estimated location of the person.

EEE9. The method of EEE 8, wherein the estimated location of the person is based, at least in part, on output signals from a plurality of microphones in the audio environment.

EEE10. The method of EEE 8 or EEE 9, wherein the one or more types of audio processing changes involve changing a rendering process to warp a rendering of audio signals away from the estimated location of the person.

EEE11. The method of any one of EEEs 1-10, wherein the one or more types of audio processing changes are based at least in part on a listening objective.

EEE12. The method of EEE 11, wherein the listening objective includes at least one of a spatial component or a frequency component.

EEE13. The method of any one of EEEs 1-12, wherein the one or more types of audio processing changes are based at least in part on one or more constraints.

EEE14. The method of EEE 13, wherein the one or more constraints are based on a perceptual model.

EEE15. The method of EEE 13 or EEE 14, wherein the one or more constraints include one or more of audio content energy preservation, audio spatiality preservation, an audio energy vector or a regularization constraint.

EEE16. The method of any one of EEEs 1-15, further comprising updating at least one of an acoustic model of the audio environment or a model of echo management system performance after causing the one or more types of audio processing changes to be applied.

EEE17. The method of any one of EEEs 1-16, wherein determining the one or more types of audio processing changes is based on an optimization of a cost function.

EEE18. The method of any one of EEEs 1-17, wherein the one or more types of audio processing changes involve spectral modification.

EEE19. The method of EEE 18, wherein the spectral modification involves reducing a level of audio data in a frequency band between 500 Hz and 3 KHz.

EEE20. The method of any one of EEEs 1-19, wherein the current utterance comprises a wakeword utterance.

EEE21. An apparatus configured to perform the method of any one of EEEs 1-20.

EEE22. A system configured to perform the method of any one of EEEs 1-20.

EEE23. One or more non-transitory media having software stored thereon, the software including instructions for controlling one or more devices to perform the method of any one of EEEs 1-20.

1. An audio processing method, comprising:
receiving, by a control system, output signals from one or more microphones in an audio environment, the output signals including signals corresponding to a current utterance of a person;
determining, by the control system, responsive to the output signals and based at least in part on audio device location information and echo management system information, one or more audio processing changes to apply to audio data being rendered to loudspeaker feed signals for two or more audio devices in the audio environment, the audio processing changes comprising a reduction in a loudspeaker reproduction level for one or more loudspeakers in the audio environment; and
causing, by the control system, the one or more types of audio processing changes to be applied.

2. The method of claim 1, wherein at least one of the one or more types of audio processing changes corresponds with an increased signal to echo ratio.

3. The method of claim 1, wherein the echo management system information comprises a model of echo management system performance.

4. The method of claim 3, wherein the model of echo management system performance comprises an acoustic echo canceller (AEC) performance matrix.

5. The method of claim 3, wherein the model of echo management system performance comprises a measure of expected echo return loss enhancement provided by an echo management system.

6. The method of claim 1, wherein the one or more types of audio processing changes are based at least in part on an acoustic model of inter-device echo and intra-device echo.

7. The method of claim 1, wherein the one or more types of audio processing changes are based at least in part on a mutual audibility matrix, the mutual audibility matrix representing energy of echo paths between the audio devices.

8. The method of claim 1, wherein the one or more types of audio processing changes are based at least in part on an estimated location of the person.

9. The method of claim 8, wherein the estimated location of the person is based, at least in part, on output signals from a plurality of microphones in the audio environment.

10. The method of claim 8, wherein the one or more types of audio processing changes involve changing a rendering process to warp a rendering of audio signals away from the estimated location of the person.

11. The method of claim 1, wherein the one or more types of audio processing changes are based at least in part on a listening objective.

12. The method of claim 11, wherein the listening objective includes at least one of a spatial component or a frequency component.

13. The method of claim 1, wherein the one or more types of audio processing changes are based at least in part on one or more constraints.

14. The method of claim 13, wherein the one or more constraints are based on a perceptual model.

15. The method of claim 13, wherein the one or more constraints include one or more of audio content energy preservation, audio spatiality preservation, an audio energy vector or a regularization constraint.

16. The method of claim 1, further comprising updating at least one of an acoustic model of the audio environment or a model of echo management system performance after causing the one or more types of audio processing changes to be applied.

17. The method of claim 1, wherein determining the one or more types of audio processing changes is based on an optimization of a cost function.

18. The method of claim 1, wherein the one or more types of audio processing changes involve spectral modification.

19. The method of claim 18, wherein the spectral modification involves reducing a level of audio data in a frequency band between 500 Hz and 3 KHz.

20. The method of claim 1, wherein the current utterance comprises a wakeword utterance.

21. An apparatus comprising:
a receiver for receiving output signals from one or more microphones in an audio environment, the output signals including signals corresponding to a current utterance of a person;
a processor for determining responsive to the output signals and based at least in part on audio device location information and echo management system information, one or more audio processing changes to apply to audio data being rendered to loudspeaker feed signals for two or more audio devices in the audio environment, the audio processing changes comprising a reduction in a loudspeaker reproduction level for one or more loudspeakers in the audio environment; and
a control system for causing the one or more types of audio processing changes to be applied.

22. (canceled)

23. One or more non-transitory media having software stored thereon, the software including instructions for controlling one or more devices to perform the method of claim 1.
